(19) United States
(12) Patent Application Publication
(10) Pub. No.: US 2020/0247932 A1
(43) Pub. Date: Aug. 6, 2020

(54) UV CURABLE COMPOSITIONS WITH CONTROLLED MECHANICAL AND CHEMICAL PROPERTIES, METHODS, AND ARTICLES THEREFROM

(71) Applicant: BASF SE, Ludwigshafen am Rhein (DE)

(72) Inventors: Paul E SHARE, Ann Arbor, MI (US); David CHEN, Cincinnati, OH (US); Stephen GODLEW, Livonia, MI (US); Emma Louise COURY, Birmingham, MI (US)

(21) Appl. No.: 16/652,223

(22) PCT Filed: Oct. 1, 2018
(86) PCT No.: PCT/US2018/053765

§ 371 Date: Mar. 30, 2020

Related U.S. Application Data
(60) Provisional application No. 62/567,093, filed on Oct. 2, 2017.

(51) Int. Cl. C08F 290/06; C08G 18/44; C08G 18/67; C08G 18/75; C08G 18/73; B33Y 10/00; B33Y 70/00

(52) U.S. Cl. CPC C08F 290/067; C08G 18/44; C08G 18/672; B33Y 70/00; C08G 18/73; B33Y 10/00; C08G 18/755

(57) ABSTRACT

Described herein is a composition including one or more ethylenically unsaturated monomers and (a) one or more oligomers represented by Formula (I):

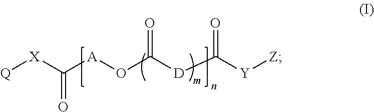

wherein: A is derived from one or more poly hydroxyl group compounds having a number average molecular weight (Mₙ) from about 250 to about 3000 g/mol; D, X, and Y are independently urethane or carbamate linkages derived from one or more polyisocyanates; Q and Z are independently derived from one or more compounds having at least one ethylenically unsaturated group; n is an integer from 1 to 20; and m is an integer from 0 to 20; or (b) one or more commercial urethane acrylates; or (c) a combination of (a) and (b); wherein the composition is a 3D UV curable composition.

### CROSS-REFERENCE TO RELATED APPLICATIONS

The present application claims the benefit of priority to U.S. Patent Application No. 62/567,093, filed on Oct. 2, 2017, the contents of which are incorporated herein in their entirety.

### FIELD

The present technology is generally related to three dimensional (3D) printing technology, and, more specifically, it is related to 3D compositions for inkjet, Stereolithography (SLA), and Digital Light Processing (DLP), and methods of use and preparation thereof.

### BACKGROUND

Oligomeric materials may be used in 3D printing compositions to achieve desirable mechanical properties to the final 3D printed object. However, materials such as urethane acrylates typically have high viscosities that are not desirable for 3D UV inkjet, SLA, or DLP technologies. The current state of the art compensates for the viscosity limitations of UV inkjet printing by using compositions having high levels (>60%) of monofunctional acrylates to achieve suitable viscosities. However, monofunctional acrylates are not capable of crosslinking and have low reactivity compared to higher functional resins, resulting in finished articles containing significant levels of unreacted monomers, and this can lead to mechanical and chemical instability.

Another disadvantage of high monomer compositions is that the high monomer dilution level reduces the contribution of the oligomer to the composition, which makes the desired mechanical properties of the finished object difficult to achieve. A significant leveling effect also occurs in high monomer compositions such that the material properties fall along a very narrow range of tensile and elongation values.

In addition, photoinitiators used to cure high monomer content UV inkjet, SLA, or DLP composition are not necessarily those which provide for optimal mechanical properties of the finished article. There is a need for materials that address the shortcomings of high monomer compositions with respect to incomplete cure, limited performance range, and multilayer performance degradation.

### SUMMARY

Another aspect of the present technology relates to an oligomer compound with one or more ethylenically unsaturated groups is provided, where the oligomer is a compound according to Formula I:

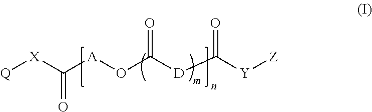

wherein:
A is derived from one or more poly hydroxyl group compounds having a molecular weight less than about 1000 g/mol;
D, X, and Y are independently urethane or carbamate linkages derived from one or more polyisocyanates;
Q and Z are independently derived from one or more compounds having at least one ethylenically unsaturated group;
n is an integer from 1 to 20; and
m is an integer from 0 to 20.

In another aspect, the present technology relates to a composition that includes one or more ethylenically unsaturated monomers and one or more of the oligomers, wherein the composition is a 3D UV curable composition.

One aspect of the present technology provides a composition including one or more ethylenically unsaturated monomers; and

(a) one or more oligomers represented by Formula (I):

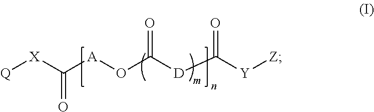

wherein: A is derived from one or more poly hydroxyl group compounds having a number average molecular weight (Mₙ) from about 250 to about 3000 g/mol; D, X, and Y are independently urethane or carbamate linkages derived from one or more polyisocyanates; Q and Z are independently derived from one or more compounds having at least one ethylenically unsaturated group; n is an integer from 1 to 20; and m is an integer from 0 to 20;
(b) a commercial urethane acrylates, wherein the commercial urethane acrylates are derived from the group consisting of polyether, polyester, polycarbonate, alkyl or aryl polyols, alkyl or aryl polyisocyanates, hydroxyl functional (meth)acrylates, and blends of polyols and/or isocyanates; or
(c) a combination of (a) and (b);
wherein the composition is a 3D UV curable composition.

In any embodiments, the compositions may be useful for inkjet, SLA, and/or DLP deposition. In any embodiments, the compositions described herein may have an oligomer content of at least about 55.0 wt. %. In any embodiments, the composition may include one or more photoinitiators. The present technology also provides a package that includes any of the compositions described herein.

In another aspect, the present technology relates to a method for preparing a 3D article using the compositions described in any embodiment herein, the method includes applying successive layers of one or more of the compositions described herein in any embodiment to fabricate a 3D article; and irradiating the successive layers with UV irradiation. In any embodiments, the composition may be inkjet, SLA, and/or DLP deposited.

In yet another related aspect, the present technology provides a 3D article that includes UV cured successive layers of any of the compositions described herein. IN any embodiments, the compositions may be deposited by inkjet, SLA, or DLP.

### BRIEF DESCRIPTION OF THE DRAWINGS

FIGS. 1A, 1B, 1C, and 1D. FIG. 1A is a graph illustrating the effect of oligomer content of various instant oligomer compositions on elongation properties of cured films, according to the examples. FIG. 1B is a graph illustrating the effect of oligomer content of various instant oligomer compositions on tensile properties of cured films, according to the examples. FIG. 1C is a graph illustrating the effect of oligomer content on the elongation properties for Oligomer I (IPDI and a 590 MW polyether polyol), according to the examples. FIG. 1D is a graph illustrating the effect of oligomer content on the tensile properties for Oligomer I (IPDI and a 590 MW polyether polyol), according to the examples.

FIG. 2 is a graph illustrating the effect of photoinitiator content on modulus at 30° C. in relation to film thickness for UV curable resins, according to the examples.

FIGS. 3A, 3B, and 3C. FIG. 3A is a graph illustrating the effect of soft segment (i.e., polyol) molecular weight on modulus, according to the examples. FIG. 3B is a graph illustrating the relationship between modulus at 30° C. and percent elongation. FIG. 3C is a graph illustrating the relationship between the elongation at break and the molecular weight of the soft segment (i.e., polyol).

FIG. 4 is a graph illustrating the rate of composition weight loss over time at 70° C. for a high oligomer content composition and a high monomer content composition, according to the examples.

FIGS. 5A and 5B. FIG. 5A is a graph illustrating the effect of curing with short and long wavelength UV irradiation on cured film modulus, according to the examples.

FIG. 5B is a graph illustrating the effect of film layer thickness on inkjet printed 3D UV curable compositions, according to the examples.

FIGS. 6A and 6B. FIG. 6A is a graph illustrating the tensile strength and elongation properties of a wide range of polyol/isocyanate combinations. FIG. 6B is a graph illustrating the effect of sample preparation and curing method on tensile and percent elongation.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, the term “substituted,” unless specifically defined differently, refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In any embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like. For some groups, substituted may provide for attachment of an alkyl group to another defined group, such as a cycloalkyl group.

As used herein, “alkyl” or “alkane” groups include straight chain and branched alkyl groups having from 1 to about 20 carbon atoms, and typically from 1 to 12 carbons or, in any embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, isobutyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In any embodiments, haloalkyl refers to a per-haloalkyl group. In general, alkyl groups may include in addition to those listed above, but are not limited to, 2-pentyl, 2-methylbutyl, 3-methylbutyl, 1,2-dimethylpropyl, 1,1-dimethylpropyl, 2,2-dimethylpropyl, 1-ethylpropyl, 2-hexyl, 2-methylpentyl, 3-methylpentyl, 4-methylpentyl, 1,2-dimethylbutyl, 1, 3Dimethylbutyl, 2,3Dimethylbutyl, 1,1-dimethylbutyl, 2,2-dimethylbutyl, 3,3Dimethylbutyl, 1,1,2-trimethylpropyl, 1,2,2-trimethylpropyl, 1-ethylbutyl, 2-ethylbutyl, 1-ethyl-2-methylpropyl, 2-heptyl, 3-heptyl, 2-ethylpentyl, 1-propylbutyl, 2-ethylhexyl, 2-propylheptyl, 1,1,3,3-tetramethylbutyl, nonyl, decyl, n-undecyl, n-dodecyl, n-tridecyl, iso-tridecyl, n-tetradecyl, n-hexadecyl, n-octadecyl, n-eicosyl, and the like.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth. Substituted groups having a single point of attachment to the compound of the present technology are not referred to using the “ene” designation.

As used herein, “alkylene” refers to a straight chain divalent alkyl group, typically having from 2 to 20 carbon atoms, or from 2 to 12 carbon atoms, or in any embodiments, from 2 to 8 carbon atoms. Alkylene groups may be substituted or unsubstituted. Examples of straight chain alkylene groups include methylene, ethylene, n-propylene, n-butylene, n-pentylene n-hexylene, n-heptylene, and n-octylene groups. Representative alkyl groups may be substituted one or more times with, for example, amino, thio, hydroxyl, cyano, alkoxy, and/or halo groups such as F, Cl, Br, and I

As used herein, “alkenyl” or “alkene” or “olefin” includes straight and branched chain alkyl groups as defined above, except that at least one double bond exists between two carbon atoms. Alkenyl groups have from 2 to 12 carbon atoms, and typically from 2 to 10 carbons or, in any embodiments, from 2 to 8, 2 to 6, or 2 to 4 carbon atoms. In any embodiments, the alkenyl group has one, two, or three carbon-carbon double bonds. Examples include, but are not limited to vinyl, allyl, —C═CH(CH₃), —CH═C(CH₃)₂, —C(CH₃)═CH₂, —C(CH₃)═CH(CH₃), —C(CH₂CH₃)═CH₂, among others. Representative substituted alkenyl groups may be mono-substituted or substituted more than once, such as, but not limited to, mono-, di- or tri-substituted with substituents such as those listed above. The terms “alkenyl,” “alkene,” and “olefin” may be used interchangeably.

Cycloalkyl groups are cyclic alkyl groups such as, but not limited to, cyclopropyl, cyclobutyl, cyclopentyl, cyclohexyl, cycloheptyl, and cyclooctyl groups. In any embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In any embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

As used herein, the term (meth)acrylic or (meth)acrylate refers to acrylic or methacrylic acid, esters of acrylic or methacrylic acid, and salts, amides, and other suitable derivatives of acrylic or methacrylic acid, and mixtures thereof. Illustrative examples of suitable (meth)acrylic monomers include, without limitation, the following methacrylate esters: methyl methacrylate, ethyl methacrylate, n-propyl methacrylate, n-butyl methacrylate (BMA), isopropyl methacrylate, isobutyl methacrylate, n-amyl methacrylate, n-hexyl methacrylate, isoamyl methacrylate, 2-hydroxyethyl methacrylate, 2-hydroxypropyl methacrylate, N,N-dimethylaminoethyl methacrylate, N,N-diethylaminoethyl methacrylate, t-butylaminoethyl methacrylate, 2-sulfoethyl methacrylate, trifluoroethyl methacrylate, glycidyl methacrylate (GMA), benzyl methacrylate, allyl methacrylate, 2-n-butoxyethyl methacrylate, 2-chloroethyl methacrylate, sec-butyl-methacrylate, tert-butyl methacrylate, 2-ethylbutyl methacrylate, cinnamyl methacrylate, crotyl methacrylate, cyclohexyl methacrylate, cyclopentyl methacrylate, 2-ethoxyethyl methacrylate, furfuryl methacrylate, hexafluoroisopropyl methacrylate, methallyl methacrylate, 3-methoxybutyl methacrylate, 2-methoxybutyl methacrylate, 2-nitro-2-methylpropyl methacrylate, n-octylmethacrylate, 2-ethylhexyl methacrylate, 2-phenoxyethyl methacrylate, 2-phenylethyl methacrylate, phenyl methacrylate, propargyl methacrylate, tetrahydrofurfuryl methacrylate and tetrahydropyranyl methacrylate. Example of suitable acrylate esters include, without limitation, methyl acrylate, ethyl acrylate, n-propyl acrylate, isopropyl acrylate, n-butyl acrylate (BA), n-decyl acrylate, isobutyl acrylate, n-amyl acrylate, n-hexyl acrylate, isoamyl acrylate, 2-hydroxyethyl acrylate, 2-hydroxypropyl acrylate, N,N-dimethylaminoethyl acrylate, N,N-diethylaminoethyl acrylate, t-butylaminoethyl acrylate, 2-sulfoethyl acrylate, trifluoroethyl acrylate, glycidyl acrylate, benzyl acrylate, allyl acrylate, 2-n-butoxyethyl acrylate, 2-chloroethyl acrylate, sec-butyl-acrylate, tert-butyl acrylate, 2-ethylbutyl acrylate, cinnamyl acrylate, crotyl acrylate, cyclohexyl acrylate, cyclopentyl acrylate, 2-ethoxyethyl acrylate, furfuryl acrylate, hexafluoroisopropyl acrylate, methallyl acrylate, 3-methoxybutyl acrylate, 2-methoxybutyl acrylate, 2-nitro-2-methylpropyl acrylate, n-octylacrylate, 2-ethylhexyl acrylate, 2-phenoxyethyl acrylate, 2-phenylethyl acrylate, phenyl acrylate, propargyl acrylate, tetrahydrofurfuryl acrylate and tetrahydropyranyl acrylate.

As used herein, the term “acrylic-containing group” or “methacrylate-containing group” refers to a compound that has a polymerizable acrylate or methacrylate group.

As used herein, the term “Stereolithography” or “SLA” refers to a form of 3D printing technology used for creating models, prototypes, patterns, and production of parts in a layer-by-layer fashion using photopolymerization, a process by which light causes chains of molecules to link, forming polymers. Those polymers then make up the body of a three-dimensional solid.

As used herein, the term “Digital Light Processing” or “DLP” refers to an additive manufacturing process, also known as 3D printing and stereolithography, which takes a design created in a 3D modeling software and uses DLP technology to print a 3D object. DLP is a display device based on optical micro-electro-mechanical technology that uses a digital micromirror device. DLP may use as a light source in printers to cure resins into solid 3D objects.

Provided herein are oligomer compounds for use in high oligomer UV curable compositions, high oligomer UV curable compositions, methods of using high oligomer UV curable compositions, and product compositions. The high oligomer compositions can be printed using inkjet print heads or other 3D printing techniques (e.g., SLA and/or DLP), and offer enhanced formula stability during the printing process, since the monomers, which represent the most volatile components of the 3D printing composition, are substantially reduced. The mechanical and chemical resistance properties of such compositions are particularly desirable in semiconductor manufacturing applications such as Chemical Mechanical Polishing (CMP), where mechanical and chemical stability and integrity of polishing pads are particularly critical. Additionally, the mechanical properties obtained can also be utilized in other applications such as conventional UV or LED printing inks and coatings, wood coatings, optical fiber coatings, laminating adhesives, and other areas in which substrate adhesion, and mechanical/chemical toughness are of interest.

The inventors of the technology described herein have found that the mechanical and chemical properties of a 3D printed object are controllable by combining monomer selection, temperature control, solvent addition, photoinitiator optimization, and/or oligomer structure. For example, the inventors have found that by preparing the certain oligomers, sometimes in combination with certain initiators, the compositions of the present technology exhibit desirable modulus, tensile, elongation, chemical resistance, and temperature that are advantageous in various applications, including three-dimensional printed articles produced by UV inkjet, SLA, or DLP printing. Moreover, the present compositions exhibit enhanced mechanical and chemical properties when used in 3D printing applications over high monomer content compositions, which currently represent the state of the art. The inventors have found that the curing and crosslinking properties of the compositions may be modified using non-acrylate functional materials such as thiols and siloxanes, which functionalities may also be present on the same molecule. The thiols are advantageous as agents to control oxygen inhibition, which can be particularly problematic in thin films such as those generated in the 3D printing process. It was also surprisingly found that specific combinations of monomers in specific ratios yield enhanced tensile and elongation properties of the composition.

It has been surprisingly found that controlling the oligomer content in the composition enhances performance properties of the cured 3D product. For example, compositions having high oligomer levels of about 55 wt % or greater exhibit improved modulus and elongation over resins having high monomer content.

Moreover, it has been found that controlling the amount of photoinitiator improves the loss of modulus of the composition during multilayer printing. Specifically, it was found that each successive layer during printing can have a negative effect upon the modulus of the underlying layers, such that the modulus of a multilayer system is lower than the properties of a single layer. In various aspects, oligomer compounds for use in UV curable compositions, UV curable compositions, methods of using UV curable compositions, and product compositions are described herein.

In one aspect, an oligomer compound with one or more ethylenically unsaturated groups is provided, where the oligomer is a compound according to Formula I:

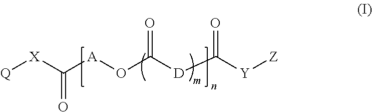

wherein:
A is derived from one or more poly hydroxyl group compounds having a molecular weight less than about 1000 g/mol;
D, X, and Y are independently urethane or carbamate linkages derived from one or more polyisocyanates;
Q and Z are independently derived from one or more compounds having at least one ethylenically unsaturated group;
n is an integer from 1 to 20; and
m is an integer from 0 to 20.

In another aspect, the present technology relates to a composition that includes one or more ethylenically unsaturated monomers and one or more of the oligomers, wherein the composition is a 3D UV curable composition.

One aspect of the present technology provides a composition including one or more ethylenically unsaturated monomers; and

(a) one or more oligomers represented by Formula (I):

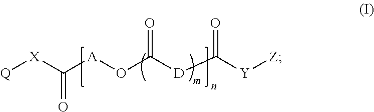

wherein: A is derived from one or more poly hydroxyl group compounds having a number average molecular weight (Mₙ) from about 250 to about 3000 g/mol; D, X, and Y are independently urethane or carbamate linkages derived from one or more polyisocyanates; Q and Z are independently derived from one or more compounds having at least one ethylenically unsaturated group; n is an integer from 1 to 20; and m is an integer from 0 to 20;

(b) a commercial urethane acrylates, wherein the commercial urethane acrylates are derived from the group consisting of polyether, polyester, polycarbonate, alkyl or aryl polyols, alkyl or aryl polyisocyanates, hydroxyl functional (meth)acrylates, and blends of polyols and/or isocyanates; or
(c) a combination of (a) and (b);
wherein the composition is a 3D UV curable composition.

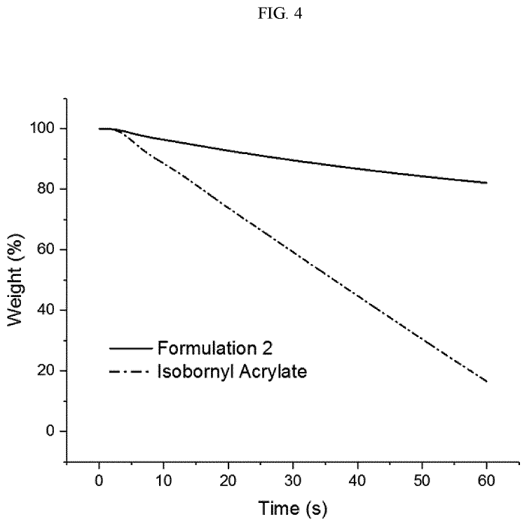

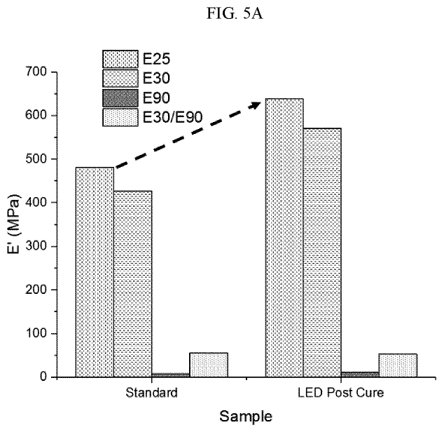

In the present technology, the oligomer structure imparts desirable mechanical and chemical properties to the 3D UV curable compositions. In particular, the structure and molecular weight of the polyol (i.e., soft segment; e.g. “the di- or tri-functional alcohol-based repeat units”), may be varied for different performance attributes. It was surprisingly found that across a wide range of polyester, polycarbonate, and polyether polyols that the incorporation of a polyol having a molecular weight of about 475 g/mol or greater affected percent elongation at break. For example, FIG. 4B illustrates a near step function between a polyol having a molecular weight of 450 g/mol and a polyol having a molecular weight of 500 g/mol.

In any embodiments, segment A may have a molecular weight of about less than about 1000 g/mol, in any embodiments. For example, a suitable molecular weight of the A segment includes about 200 g/mol to about 1000 g/mol, about 250 g/mol to about 900 g/mol, about 250 g/mol to about 750 g/mol, about 250 g/mol to about 500 g/mol, about 300 g/mol to about 600 g/mol, or about 500 g/mol to about 900 g/mol. In one embodiment, segment A has a molecular weight of about 250 g/mol to about 1000 g/mol. In another embodiment, segment A has a molecular weight of about 250 g/mol to about 500 g/mol. In any embodiments, segment A may have a molecular weight less than about 400 g/mol.

In any embodiments, segment A may have a molecular weight of about 475 g/mol to about 3000 g/mol, about 500 g/mol to about 3000 g/mol, or about 1000 g/mol to about 3000 g/mol. For example, a suitable molecular weight of A segment includes about 475 g/mol to about 2500 g/mol, about 475 g/mol to about 2000 g/mol, about 475 g/mol to about 1500 g/mol, about 1250 g/mol to about 2900 g/mol, about 1250 g/mol to about 2750 g/mol, about 1250 g/mol to about 2500 g/mol, about 1300 g/mol to about 2300 g/mol, or about 1500 g/mol to about 2300 g/mol. In one embodiment, segment A has a molecular weight of about 1000 g/mol to about 3000 g/mol. In another embodiment, segment A has a molecular weight of about 1250 g/mol to about 2500 g/mol.

In any embodiments, segment A may be

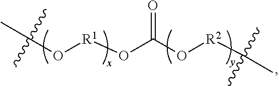

where R¹ and R² may be independently derived from a diol or triol polycarbonate, a diol or triol linear C₁ to C₁₀ alkane, a diol or triol branched C₁ to C₁₀ alkane, or a C₁ to C₁₀ alkylene optionally substituted with a C₁ to C₆ alkyl.

In any embodiments of Formula I, x may be an integer from 1 to 20. In another embodiment, x may be an integer from 1 to 10. In yet another embodiment, x may be 1, 2, 3, 4, or 5. In any embodiments of Formula I, y may be an integer from 0 to 20. In another embodiment, y may be an integer from 0 to 10. In yet another embodiment, y may be 0 or 1.

According to any of the above embodiments, the A segment may be derived from polyethylene glycol, a compound of Formula (II), and/or a compound of Formula (III):

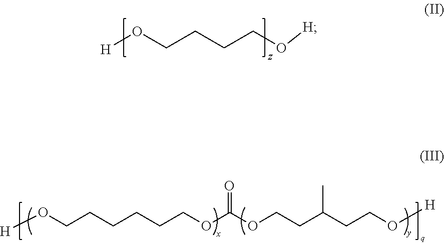

wherein: q is 1-20; x is 1-20; y is 1-20; z is 1-40.

In any embodiments, the A segment is derived from a compound of Formula (II). In any embodiments of Formula (II), z may be an integer from 1 to 10. In another embodiment of Formula (II), z may be 1, 2, 3, 4, or 5. In any embodiments of Formula (II), the compound of Formula (II) has a molecular weight of less than about 400 g/mol. For example, a suitable molecular weight of Formula (II) includes about 100 g/mol to about 400 g/mol, about 150 g/mol to about 350 g/mol, about 200 g/mol to about 350 g/mol, or about 250 g/mol to about 300 g/mol.

In any embodiments, the A segment is derived from a compound of Formula (III). In Formula (III), q may be an integer from 1 to 20, or from 1 to 10. In another embodiment of Formula (III), q is 1, 2, 3, 4, or 5. In Formula (III), x may be an integer from 1 to 20. In another embodiment of Formula (III), x is 1, 2, 3, 4, or 5. In Formula (III), y may be an integer from 1 to 20. In another embodiment of Formula (III), y is 1, 2, 3, 4, or 5.

The A segment is derived from a compound of Formula (II) or Formula (III) may have a molecular weight of about 1000 g/mol to about 3000 g/mol, in any embodiments. For example, a suitable molecular weight of the A segment includes about 1000 g/mol to about 3000 g/mol, about 1250 g/mol to about 2900 g/mol, about 1250 g/mol to about 2750 g/mol, about 1250 g/mol to about 2500 g/mol, about 1300 g/mol to about 2300 g/mol, or about 1500 g/mol to about 2300 g/mol. In one embodiment, segment A has a molecular weight of about 1000 g/mol to about 3000 g/mol. In another embodiment, segment A has a molecular weight of about 1250 g/mol to about 2500 g/mol.

In any embodiments, the A segment is derived from polyethylene glycol, a compound of Formula (II), or a compound of Formula (III). In any embodiments, the polyethylene glycol, a compound of Formula (II), or a compound of Formula (III) may have a molecular weight of about 250 g/mol to about 3000 g/mol. In any embodiments, the polyethylene glycol, a compound of Formula (II), or a compound of Formula (III) may have a molecular weight of about 475 g/mol to about 3000 g/mol, about 500 g/mol to about 3000 g/mol, or about 1000 g/mol to about 3000 g/mol. For example, a suitable molecular weight of the polyethylene glycol, a compound of Formula (II), or a compound of Formula (III) includes about 475 g/mol to about 2500 g/mol, about 475 g/mol to about 2000 g/mol, about 475 g/mol to about 1500 g/mol, about 1250 g/mol to about 2900 g/mol, about 1250 g/mol to about 2750 g/mol, about 1250 g/mol to about 2500 g/mol, about 1300 g/mol to about 2300 g/mol, or about 1500 g/mol to about 2300 g/mol. In one embodiment, the polyethylene glycol, a compound of Formula (II), or a compound of Formula (III) has a molecular weight of about 1000 g/mol to about 3000 g/mol. In another embodiment, the polyethylene glycol, a compound of Formula (II), or a compound of Formula (III) has a molecular weight of about 1250 g/mol to about 2500 g/mol. In any embodiments, the A segment is derived from polyethylene glycol.

According to any of the above embodiments, the D segment may be wherein D is

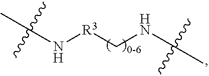

where R³ is a substituted or unsubstituted arylene, substituted or unsubstituted cycloalkylene, or substituted or unsubstituted C₁-C₁₀-alkylene. In any embodiments, R³ may be a substituted or unsubstituted arylene. In any embodiments, R³ may be a substituted or unsubstituted cycloalkylene. In any embodiments, R³ may be a substituted or unsubstituted C₁ to C₁₀ alkylene.

According to any embodiment, the X and Y segments may independently be

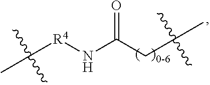

where R⁴ is a substituted or unsubstituted arylene, substituted or unsubstituted cycloalkylene, or substituted or unsubstituted C₁-C₁₀-alkylene. In any embodiments, R⁴ may be a substituted or unsubstituted arylene. In any embodiments, R⁴ may be a substituted or unsubstituted cycloalkylene. In any embodiments, R⁴ may be a substituted or unsubstituted C₁ to C₁₀ alkylene. In one embodiment, R³ and R⁴ independently may be:

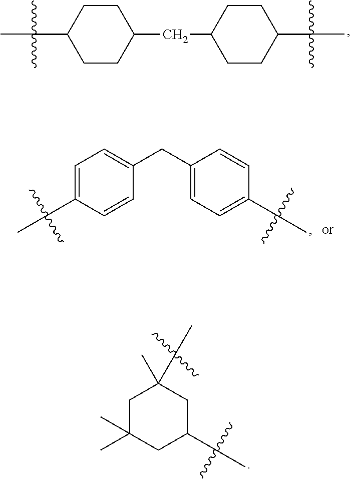 [SMILES: *C1CCC(CC2CCC(*)CC2)CC1 ; *c1ccc(Cc2ccc(*)cc2)cc1 ; *C1CC(*)(C)CC(C)(C)C1]

According to any embodiment, the D, X, and Y segments may independently be urethane or carbamate linkages derived from one or more polyisocyanates. For example, suitable polyisocyanates include, but are not limited to, tetramethylene diisocyanate, hexamethylene diisocyanate, octamethylene diisocyanate, decamethylene diisocyanate, dodecamethylene diisocyanate, tetradecamethylene diisocyanate, lysine diisocyanate, tetramethylxylylene diisocyanate, trimethylhexane diisocyanate, tetramethylhexane diisocyanate, 1,4-diisocyanatocyclohexane, 1,3-diisocyanatocyclohexane, 1,2-diisocyanatocyclohexane, 4,4′-di(isocyanatocyclohexyl)methane, 2,4′-di(isocyanatocyclohexyl)methane, 1,3-bis(isocyanatomethyl)cyclohexane, 1,4-bis(isocyanatomethyl)cyclohexane, 2,4-diisocyanato-1-methylcyclohexane, 2,6-diisocyanato-1-methylcyclohexane, tolylene-2,4-diisocyanate, tolylene-2,6-diisocyanate, m-xylylene diisocyanate, p-xylylene diisocyanate, 2,4′-diisocyanato-diphenylmethane, 4,4′-diisocyanato-diphenylmethane, phenylene-1,3Diisocyanate, phenylene-1,4-diisocyanate, 1-chlorophenylene-2,4-diisocyanate, naphthylene-1,5-diisocyanate, diphenylene-4,4′-diisocyanate, 4,4′-diisocyanato-3,3′-dimethylbiphenyl, 3-methyldiphenylmethane-4,4′-diisocyanate, tetramethylxylylene diisocyanate, 1,4-diisocyanatobenzene, diphenylether-4,4′-diisocyanate, 1,4-diisocyanatobutane, 1,5-diisocyanatopentane, hexamethylene diisocyanate (HDI), 1,11-diisocyanatoundecane, 1,12-diisocyanatododecane, 2,2,4-trimethyl-1,6-diisocyanatohexane, 2,4,4-trimethyl-1,6-diisocyanatohexane, isophorone diisocyanate (IPDI), methylene diphenyl diisocyanate (MDI), 1, 3Diisocyanatocyclobutane, 1,3-diisocyanatocyclohexane, 1,4-diisocyanatocyclohexane, 4,4′-bis-(isocyanatocyclohexyl)-methane (HMDI), 1,2-bis-(isocyanatomethyl)-cyclobutane, 1,3-bis-(isocyanatomethyl)-cyclohexane, 1,4-bis-(isocyanatomethyl)-cyclohexane, hexahydro-2,4-diisocyanatotoluene, hexahydro-2,6-diisocyanatotoluene, bis-isocyanatomethyl norbornane, 2,5-bis-(isocyanatomethyl)-bicyclo[2.2.1]heptane, 2,6-bis-(isocyanatomethyl)-bicyclo[2.2.1]heptane, 1-isocyanato-4(3)-isocyanatomethyl-1-methyl cyclohexane, p-xylylene diisocyanate, 2,3-bis-(8-isocyanatooctyl)-4-octyl-5-hexyl cyclohexane, and mixtures of two or more thereof. In any embodiments, the one or more polyisocyanates include IPDI, MDI, HMDI, and mixtures of two or more thereof.

In Formula I, m may be an integer from 0 to 20, from 0 to 10, or where m is 0 or 1.

According to any embodiments, the Q and Z segments may independently be derived from one or more compounds having at least one ethylenically unsaturated group. For example, suitable compounds having at least one ethylenically unsaturated group include, but are not limited to, allyl alcohol, 2-hydroxyethyl vinyl ether, 4-hydroxybutyl vinyl ether, glycerol diallyl ether, trimethylolpropane diallyl ether, pentaerythritol triallyl ether, 2-hydroxyethylacrylate, 2-hydroxyethylmethacrylate, polyethylene glycol acrylate, polyethylene glycol methacrylate, glycerol diacrylate, glycerol dimethacrylate, trimethyolpropane diacrylate, trimethylolpropane dimethacrylate, pentaerythritol triacrylate, and pentaerythritol trimethacrylate, or mixtures of two or more thereof. In any embodiments, the Q and Z segments may be derived from 2-hydroxyethyl acrylate, 2-hydroxyethyl methacrylate, 2-hydroxyethyl vinyl ether, and mixtures of two or more thereof.

Illustrative examples of the oligomer of Formula I may be represented by Formula (IV) or Formula (V), where any variables are as defined above:

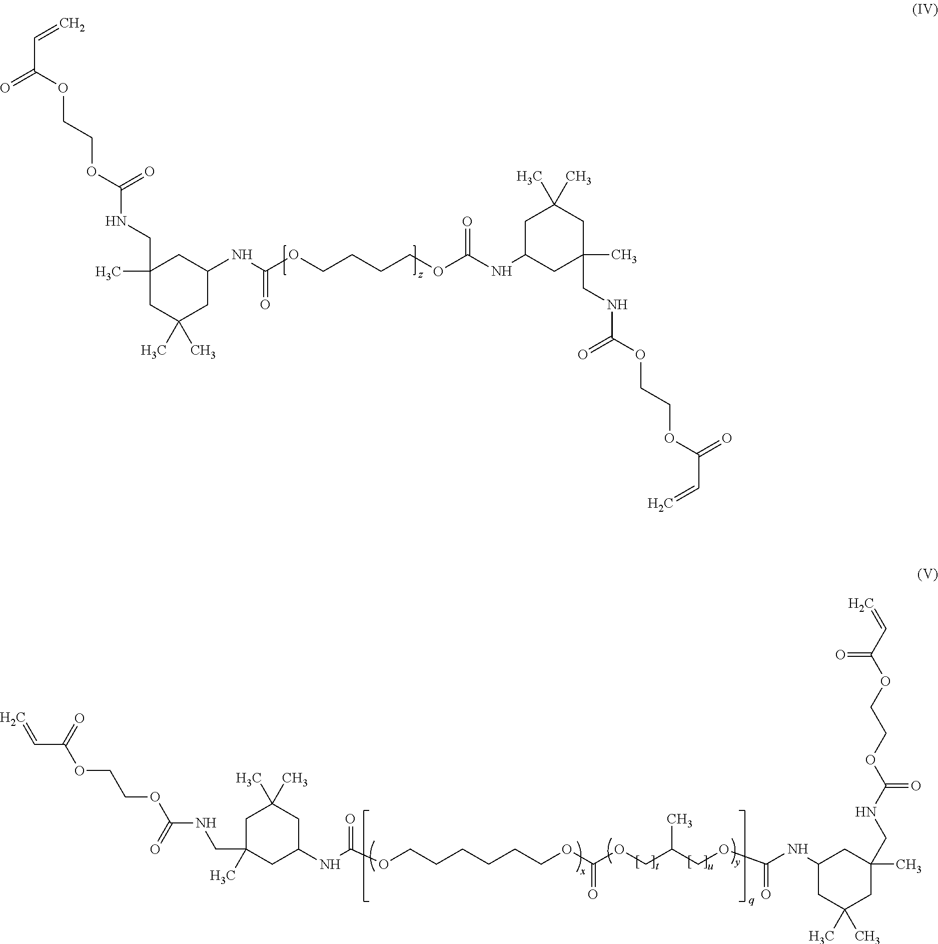

wherein t and u are 2.

In any embodiments, the oligomer may be a compound of Formula IV, a compound of Formula V, or combinations of two or more thereof. In any embodiments, the oligomer may be a commercial urethane acrylate. For example, suitable commercial urethane acrylates include, but are not limited to, urethane acrylates based on polyether, polyester, polycarbonate, alkyl or aryl polyols, aryl or alkyl polyisocyanates, hydroxyl functional (meth) acrylates, blends of such polyols and/or isocyanates, and combinations of two or more thereof.

The compositions may include a high oligomer content, for example about 55 wt. % or greater of one or more oligomers. Suitable amounts of oligomer include, but are not limited to, greater than about 55 wt. %, greater than about 60 wt. %, greater than about 65 wt. %, greater than about 70 wt. %, greater than about 75 wt. %, greater than about 80 wt. %, greater than about 85 wt. %, greater than about 90 wt. %, or a range between any two of these values. In any embodiments, the composition has an oligomer content from about 55 wt. % to about 85 wt. %, from about 60 wt. % to about 85 wt. %, or from about 75 wt. % to about 90 wt. %.

In any embodiments, the one or more ethylenically unsaturated monomers are present in an amount of about 45 wt. % or less. Suitable amounts of the vinyl and/or (meth)acrylate monomer include, but are not limited to, about 10 wt. % to about 45 wt. %, about 15 wt. % to about 40 wt. %, or about 10 wt. % to about 30 wt. %.

In any embodiments, the one or more ethylenically unsaturated monomers may include a vinyl and/or (meth)acrylate monomer. Suitable ethylenically unsaturated monomers include, but are not limited to, (meth)acrylate monomers, (meth)acrylamide monomers, vinyl monomers, and combinations thereof. For example, suitable (meth)acrylate and (meth)acrylamide monomers include, but are not limited to, isobornyl (meth)acrylate, phenoxyethyl (meth)acrylate, tert-butyl cyclohexyl (meth)acrylate, hexanediol di(meth)acrylate, trimethylolpropane formal (meth)acrylate, polyethylene glycol di(meth)acrylate, isodecyl (meth)acrylate, hexyl (meth)acrylate, cyclohexyl (meth)acrylate, 2-ethylhexyl(meth) acrylate, octyl (meth)acrylate, nonyl (meth)acrylate, stearyl (meth)acrylate, 2-phenoxy (meth)acrylate, 2-methoxyethyl (meth)acrylate, lactone modified esters of acrylic acid, lactone modified esters of methacrylic acid, methacrylamide, methyl (meth)acrylate, butyl (meth)acrylate, isobutyl (meth)acrylate, allyl (meth)acrylate, tetrahydrofuryl (meth)acrylate, n-hexyl (meth)acrylate, 2-(2-ethoxyethoxy)ethyl (meth)acrylate, n-lauryl (meth)acrylate, 2-phenoxyethyl (meth)acrylate, glycidyl (meth)acrylate, glycidyl (meth)acrylate, (meth)acrylated methylolmelamine, 2-(N,N-diethylamino)-ethyl (meth)acrylate, neopentyl glycol di(meth)acrylate, alkoxylated neopentyl glycol di(meth)acrylate, ethylene glycol di(meth)acrylate, hexylene glycol di(meth)acrylate, diethylene glycol di(meth)acrylate, tripropylene glycol di(meth)acrylate, tetraethylene glycol di(meth)acrylate, pentaerythritol di(meth)acrylate, pentaerythritol tri(meth)acrylate, pentaerythritol tetra(meth)acrylate, pentaerythritol penta(meth)acrylate, trimethylolpropane tri(meth)acrylate, phenoxyethyl (meth)acrylate, hexanediol di(meth)acrylate, 4-tert-butyl cyclohexyl (meth)acrylate, alkoxylated trimethylolpropane tri(meth)acrylate which contains from 2 to 14 moles of either ethylene or propylene oxide, triethylene glycol di(meth)acrylate, tetraethylene glycol di(meth)acrylate, butyl-allyl-ether isobornyl (meth)acrylate, polyethylene glycol di(meth)acrylate, and 4-acryloyl morpholine.

Suitable vinyl monomers include, but are not limited to, N-vinylformamide (NVF), adducts of NVF having diisocyanates such as toluene diisocyanate and isophorone diisocyanate (IPDI), derivatives of N-vinylformamide, N-vinylcaprolactam, N-vinylpyrrolidone, butyl-vinylether, 1,4-butyl-divinylether, dipropyleneglycol-divinylether, triallylisocyanurate, diallylphthalate, and vinyl esters of acetic acid, lauryl acid, dodecanoic acid, cyclohexylcarboxylic acid, adipic acid, glutaric acid and the like.

The compositions may include one or more photoinitiators. Suitable photoinitiators include, but are not limited to, bis(2,4,6-trimethylbenzoyl)-phenylphosphine oxide, 2,4,6-trimethylbenzoylphenyl phosphinate, bis(2,6-dimethoxybenzoyl)-2,4,4-trimethylpentylphosphine oxide, diphenyl(2,4,6-trimethylbenzoyl)phosphine oxide, alpha-hydroxycyclohexyl phenyl ketone, 2-hydroxy-1-(4-(4-(2-hydroxy-2-methylpropionyl)benzyl)phenyl-2-methylpropan-1-one, 2-hydroxy-2-methyl-1-phenylpropanone, 2-hydroxy-2-methyl-1-(4-isopropylphenyl)propanone, oligo (2-hydroxy-2-methyl-1-(4-(1-methylvinyl)phenyl)propanone, 2-hydroxy-2-methyl-1-(4-dodecylphenyl)propanone, 2-hydroxy-2-methyl-1-[(2-hydroxyethoxy)phenyl]propanone, benzophenone, substituted benzophenones, and mixtures of any two or more thereof. In any embodiments, the one or more photoinitiators may be diphenyl(2,4,6-trimethylbenzoyl)phosphine oxide, and combinations of two or more thereof.

In any embodiments, the one or more photoinitiators may be present in an amount of about 0.01 wt. % to about 6.0 wt. % of the total weight of the composition. Suitable amounts of the photoinitiator include, but are not limited to, about 0.01 wt. % to about 6.0 wt. %, about 0.1 wt. % to about 4.0 wt. %, about 0.20 wt. % to about 2.0 wt. %, or about 0.5 wt. % to about 1.0 wt. %. In one embodiment, the photoinitiator is present in an amount from 0.25 wt. % to about 2.0 wt. %. In another embodiment, the photoinitiator is present in an amount from 0.5 wt. % to about 1.0 wt. %.

The viscosity of the compositions may also be controlled. It may be useful to control the viscosity of the compositions at temperatures commonly used in various printing and other applications, such as 3D inkjet, SLA, and/or DLP printing. For applications such as jetting, the composition typically has a viscosity of about 35 mPa·s or less. Suitable viscosities include, but are not limited to, about 35 mPa·s, about 30 mPa·s, about 25 mPa·s, about 20 mPa·s, about 18 mPa·s, about 15 mPa·s, about 12 mPa·s, about 10 mPa·s, or values between any two of these values or less than any one of these values. In any embodiments, the composition has a viscosity from about 10 mPa·s to about 35 mPa·s, about 10 mPa·s to about 20 mPa·s, or about 10 mPa·s to about 15 mPa·s. In any embodiments, the composition exhibits a viscosity of 35 mPa·s or less at temperatures in the range of about 25° C. to about 130° C. In another embodiment, the viscosity is from about 10 mPa·s to about 20 mPa·s at a temperature from about 25° C. to about 130° C. For applications such as SLA or DLP, the viscosity may be significantly higher, typically from about 100 mPas to 10,000 mPas at 25° C. (including about 500 mPas to 9,000 mPas, about 1000 mPas to 8,000 mPas, about 2000 mPas to 7,000 mPas, about 3000 mPas to 6,000 mPas, about 4000 mPas to 5,000 mPas, about 100 mPas to 5,000 mPas, about 200 mPas to 3,000 mPas, about 300 mPas to 1,000 mPas, about 5,000 mPas to 10,000 mPas, or about 7,000 mPas to 9,000 mPas).

According to any embodiments, the compositions may further include a solvent. Suitable solvents include, but are not limited to, propylene glycol monomethyl ether acetate, tripropylene glycol methyl ether, tripropylene glycol n-butyl ether, propylene glycol methyl ether, propylene glycol phenyl ether, propylene glycol n-butyl ether, propylene glycol diacetate, dipropylene glycol methyl ether, dipropylene glycol n-propyl ether, dipropylene glycol n-butyl ether, dipropylene glycol dimethyl ether, and mixtures of two or more thereof.

According to any embodiments, the compositions may further include nanoparticles. Suitable nanoparticles include, but are not limited to, organocation-modified phyllosilicates, TiO₂, ZnO, Ag, SiO₂, Fe₃O₄, CaCO₃, Al₂O₃, Mg(OH)₂, Al(OH)₃, CeO₂, MnO₂, cellulose, graphene, carbon fiber, carbon nanotube, cloisite, montmorillonite, hectorite, saponite, or the like and mixtures of two or more thereof. In any embodiments, the nanoparticle may be an organocation-modified phyllosilicate. In any embodiments, the organocation-modified phyllosilicate is alkylammonium cation exchanged montmorillonite.

According to any embodiments, the compositions may further include performance modifiers. Suitable performance modifiers include, but are not limited to, thiols, silyl acrylates, and thiol-functional silanes. In any embodiments, the performance modifier is a thiol. For example, suitable thiols include, but are not limited to, 1-pentanethiol, 1-hexanethiol, 1-heptanethiol, 1-octanethiol, 1-decanethiol, 1-dodecanethiol, 1-hexadecanethiol, 1-octadecanethiol, cyclohexanethiol, eicosanethiol, docosanethiol, tetracosanethiol, hexacosanethiol, octacosanethiol, t-dodecyl mercaptan, methyl thioglycolate, methyl-3-mercaptopropionate, ethyl thioglycolate, butyl thioglycolate, butyl-3-mercaptopropionate, isooctyl thioglycolate, isooctyl-3-mercaptopropionate, isodecyl thioglycolate, isodecyl-3-mercaptopropionate, dodecyl thioglycolate, dodecyl-3-mercaptopropionate, octadecyl thioglycolate, octadecyl-3-mercaptopropionate, thioglycolic acid, 3-mercaptopropionic acid, and mixtures of two or more thereof.

In any embodiments, the performance modifier may be a thio-functional silane. For example, suitable thio-functional silanes include, but are not limited, bis(3-triethoxysilylpropyl)-tetrasulfide, gamma-mercaptopropyltimethoxysilane, gamma-mercaptopropyl-triethoxysilane, and mixtures of two or more thereof.

The compositions of the present technology may further include reaction products obtained from reacting one or more polyisocyanates and one or more compounds having at least one ethylenically unsaturated group. According to any embodiments, the composition may further include a compound of Formula (VI):

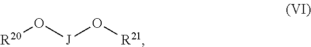

wherein:

R²⁰ and R²¹ are independently comprise a (meth)acrylate moiety derived from one or more compounds comprising at least one ethylenically unsaturated group; and J is a divalent urethane compound derived from one or more polyisocyanates.

In any embodiments of Formula (VI), the (meth)acrylate moiety may be derived from one or more compounds having at least one ethylenically unsaturated group. Suitable compounds having at least one ethylenically unsaturated group include, but are not limited to, allyl alcohol, 2-hydroxyethyl vinyl ether, 4-hydroxybutyl vinyl ether, glycerol diallyl ether, trimethylolpropane diallyl ether, pentaerythritol triallyl ether, 2-hydroxyethylacrylate, 2-hydroxyethylmethacrylate, polyethylene glycol acrylate, polyethylene glycol methacrylate, glycerol diacrylate, glycerol dimethacrylate, trimethyolpropane diacrylate, trimethyolpropane dimethacrylate, pentaerythritol triacrylate, pentaerythritol trimethacrylate, and mixtures of two or more thereof.

In any embodiments of Formula (VI), the divalent urethane compound may be derived from one or more polyisocyanates. Suitable polyisocyanates include, but are not limited to, tetramethylene diisocyanate, hexamethylene diisocyanate, octamethylene diisocyanate, decamethylene diisocyanate, dodecamethylene diisocyanate, tetradecamethylene diisocyanate, lysine diisocyanate, tetramethylxylylene diisocyanate, trimethylhexane diisocyanate, tetramethylhexane diisocyanate, 1,4-diisocyanatocyclohexane, 1,3-diisocyanatocyclohexane, 1,2-diisocyanatocyclohexane, 4,4′-di(isocyanatocyclohexyl)methane, 2,4′-di(isocyanatocyclohexyl)methane, isophorone diisocyanate (IPDI), 1,3-bis(isocyanatomethyl)cyclohexane, 1,4-bis(isocyanatomethyl)cyclohexane, 2,4-diisocyanato-1-methylcyclohexane, 2,6-diisocyanato-1-methylcyclohexane, tolylene 2,4-diisocyanate, tolylene 2,6-diisocyanate, m-xylylene diisocyanate, p-xylylene diisocyanate, 2,4′-diisocyanato-diphenylmethane, phenylene, 4,4′-diisocyanato-diphenylmethane, phenylene 1,3-diisocyanate, phenylene 1,4-diisocyanate, 1-chlorophenylene 2,4-diisocyanate, naphthylene 1,5-diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene, diphenyl ether 4,4′-diisocyanate, 1,4-diisocyanatobutane, 1,5-diisocyanatopentane, hexamethylene diisocyanate (HDI), 1,11-diisocyanatoundecane, 1,12-diisocyanatododecane, 2,2,4-trimethyl-1,6-diisocyanatohexane, 2,4,4-trimethyl-1,6-diisocyanatohexane, methylene diphenyl diisocyanate (MDI), 1, 3Diisocyanatocyclobutane, 1,3Diisocyanatocyclohexane, 1,4-diisocyanatocyclohexane, 4,4′-bis-(isocyanatocyclohexyl)-methane (HMDI), 1,2-bis-(isocyanatomethyl)-cyclobutane, 1,3- and 1,4-bis-(isocyanatomethyl)-cyclohexane, hexahydro-2,4-diisocyanatotoluene, hexahydro-2,6-diisocyanatotoluene, bis-isocyanatomethyl norbornane, 2,5-bis-(isocyanatomethyl)-bicyclo[2.2.1]heptane, 2,6-bis-(isocyanatomethyl)-bicyclo[2.2.1]heptane, 1-isocyanato-4(3)-isocyanatomethyl-1-methyl cyclohexane, p-xylylene diisocyanate, 2,3-bis-(8-isocyanatooctyl)-4-octyl-5-hexyl cyclohexane, and mixtures of two or more thereof.

According to any embodiments, the composition may further include ethylenically functional or non-functional non-urethane oligomers, which may further enhance the mechanical and chemical properties of the composition of the present technology. Suitable non-urethane oligomers include, but are not limited to, epoxy, ethoxylated or propoxylated epoxy resins, polyesters, polyethers, polyesters, polyketones, and mixtures of two or more thereof.

In an aspect of the present technology, a process for preparing an oligomer as described herein in any embodiment is provided, the process includes reacting one or more polyisocyanates with one or more compounds having at least one ethylenically unsaturated group and one or more poly hydroxyl group compounds, where the process is carried out thermally or in the presence of a catalyst.

In any embodiments, the process may include reacting the one or more polyisocyanates with the one or more compounds having at least one ethylenically unsaturated group to form an ethylene-isocyanate intermediate having urethane bound ethylenically unsaturated groups and unreacted isocyanate groups. In any embodiments, the process further includes reacting the urethane-isocyanate intermediate with the one or more poly hydroxyl group compounds.

In any embodiments, the process may include reacting the one or more polyisocyanates with the one or more poly hydroxyl group compounds to form a poly hydroxyl-isocyanate intermediate having a urethane bound poly hydroxyl group compound and unreacted isocyanate groups. In any embodiments, the poly hydroxyl-isocyanate intermediate includes hydroxyl groups of the bound poly hydroxyl groups that have reacted and isocyanate groups that are unreacted. In any embodiments, the process further includes reacting the poly hydroxyl-isocyanate intermediate with the one or more compounds having at least one ethylenically unsaturated compounds. In any embodiments, the process includes reacting the one or more polyisocyanates, one or more compounds having at least one ethylenically unsaturated group, and one or more poly hydroxyl group compounds in one reaction step.

In any embodiments, the process includes the one or more polyisocyanates, poly hydroxyl group compounds, and the one or more compounds comprising at least one ethylenically unsaturated group as described herein.

According to any embodiment, the process may be carried out thermally or in the presence of a catalyst. In any embodiments, the process is carried out thermally. For example, the process is carried under thermal conditions suitable for polymerization. In any embodiments, the process is carried out in the presence of a catalyst. For example, suitable catalysts include, but are not limited to, organozinc, tetraalkylammonium, or organotin compounds. In any embodiments, the catalyst is an organozinc compound. For example, suitable organozinc compounds include, but are not limited to, zinc acetylacetonate, zinc 2-ethylcaproate, and the like. In any embodiments, the catalyst is a tetraalkylammonium compound. For example, suitable tetraalkylammonium compounds include, but are not limited to, N,N,N-trimethyl-N-2-hydroxypropylammonium hydroxide, N,N,N-trimethyl-N-2-hydroxypropylammonium 2-ethylhexanoate, and the like. In any embodiments, the catalyst is an organotin compound. For example, suitable organotin compounds include, but are not limited to, dibutyltin dilaurate.

According to any embodiment, the process may be carried out at a temperature of about 25° C. to about 100° C. For example, suitable temperatures include, but are not limited to, about 25° C. to about 100° C., about 25° C. to about 75° C., about 25° C. to about 50° C., or about 50° C. to about 100° C.

In another aspect, a method is provided for preparing a 3D article using any of the compositions described in any embodiment herein. The method includes applying successive layers of one or more of the compositions described herein in any embodiment to fabricate a 3D article; and irradiating the successive layers with UV irradiation.

Applying the composition to obtain the three-dimensional article may include depositing the composition. In any embodiments, the application may include depositing a first layer of the composition and second layer of the composition to the first layer and successive layers thereafter to obtain a 3D article. Such depositing may include one or more methods, including but not limited to, UV inkjet printing, SLA, continuous liquid interface production (CLIP), and DLP. Other applications for the compositions include, but are not limited to, other coating and ink applications for printing, packaging, automotive, furniture, optical fiber, and electronics.

The methods described herein include contacting the layers of the composition with ultraviolet light irradiation to induce curing of the composition. In any embodiments, the contacting includes short wavelength and long wavelength ultraviolet light irradiation. Suitable short wavelength ultraviolet light irradiation includes UV-C or UV-B irradiation. In one embodiment, the short wavelength ultraviolet light irradiation is UV-C light. Suitable longwave ultraviolet light irradiation includes UV-A irradiation. Additionally, Electron Beam (EB) irradiation may be utilized to induce curing of the composition.

The methods described herein include repeating the deposition of layers of the composition and exposure to UV irradiation to obtain the 3D article. In any embodiments, the repeating may occur sequentially wherein depositing the layers of composition is repeated to obtain the 3D article prior to exposure to UV irradiation. In any embodiments, the repeating may occur subsequently wherein the deposing the layers of composition and exposure to UV irradiation are repeated after both steps.

In another related aspect, a 3D article is provided that includes UV cured successive layers of the any of the compositions as described herein. In any embodiments, the composition may have been inkjet, SLA, or DLP deposited.

In any embodiments, the 3D article may include a polishing pad. In any embodiments, polishing pad is a chemical mechanical polishing (CMP) pad. Polishing pads may be made following any known methods, for example the methods provided in U.S. Patent Appl. No. 2016/0107381, U.S. Patent Appl. No. 2016/0101500, and U.S. Pat. No. 10,029,405 (each incorporated herein by reference).

The 3D article of the present technology exhibits improved tensile strength, modulus, and elongation properties. In any embodiments, the three-dimensional article exhibits a tensile strength of about 500 psi to about 10,000 psi. For example, the three-dimensional article may exhibit a tensile strength, including but not limited to, about 500 psi to about 10,000 psi, about 1,000 psi to about 7,500 psi, about 2,500 psi to about 6,000 psi, or about 3,000 psi to about 5,000 psi.

In any embodiments, the 3D article has a modulus of about 500 MPa to about 10,000 MPa. For example, the 3D article may exhibit a modulus, including but not limited to, about 500 MPa to about 10,000 MPa, about 1,000 MPa to about 7,500 MPa, about 2,500 MPa to about 6,000 MPa, or about 3,000 MPa to about 5,000 MPa.

In any embodiments, the 3D article of the present technology may exhibit improved elongation properties while maintaining its tensile strength and modulus. Is any embodiments, the 3D article exhibits an elongation of about 5% to about 300%. For example, the 3D article may exhibit an elongation, including but not limited to, about 5% to about 300%, about 5% to about 250%, about 5% to about 200%, about 5% to about 150%, about 5% to about 100%, about 5% to about 50%, or about 5% to about 35%.

The present technology, thus generally described, will be understood more readily by reference to the following examples, which are provided by way of illustration and are not intended to be limiting of the present invention.

### EXAMPLES

The following abbreviations and terms are used herein:
IBOA: isobornyl acrylate;
NVC: n-vinyl caprolactam;
POEA: phenoxyethyl acrylate;
HDDA: hexanediol diacrylate;
DVE-3: triethylene glycol divinyl ether;
TPGDA: tripropyleneglycol diacrylate;
DPGDA: dipropylene glycol diacrylate;
PPTTA: ethoxylated pentaerythritol tetraacrylate;
TBCH: 4-tert-butyl cyclohexyl acrylate; and
TPO: diphenyl(2,4,6-trimethylbenzoyl)phosphine oxide.
PolyTHF®250: polytetramethylene glycol based polyether diol having a molecular weight of about 225 g/mol to about 275 g/mol, available from BASF SE.
Polyol C-590®, -1090®, -2050®, -2090°, and -3090®: 9:1 ratio 2-methyl-1,3-propanediol and 1,6-hexanediol based polycarbonate diol having a molecular weight of about 500 g/mol, 1000 g/mol, 2000 g/mol, 2000 g/mol, and 3000 g/mol, respectively, available from Kuraray America, Inc.

### Example 1: Synthesis of Urethane Acrylate Oligomers

### Oligomer A

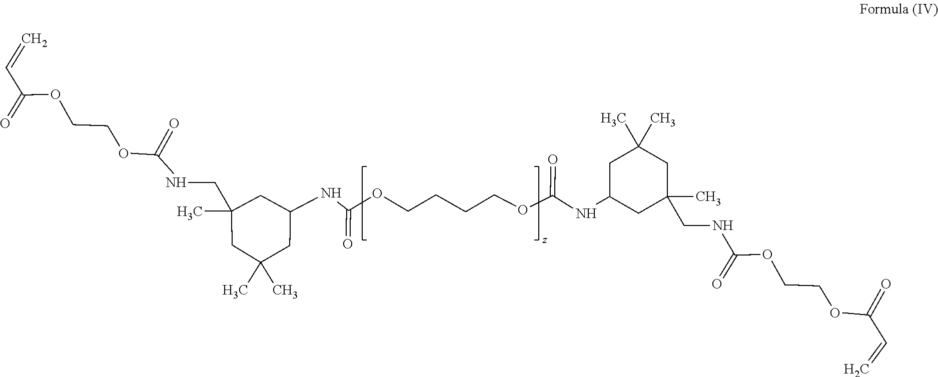

Polyether diol (PolyTHF® 250, 190.50 g, about 0.76 mol, about 1.52 mol of OH groups), hydroxyethyl acrylate (158.74 g, 1.22 moles), ethyl acetate (298.65 g; 3.39 mol), hydroquinone methyl ether (0.050 g; 0.4 mmol), butylated hydroxytoluene (1.0 g; 4.5 mmol), phenothiazine (0.1 g; 0.5 mmol), and a zinc neodecanoate catalyst (1.0 g, 2.45 mmol) were introduced into a 1.5 L kettle style reactor with nitrogen inlet and condenser at room temperature. The temperature was increased to 35° C., and isophorone diisocyanate (338.11 g; 1.52 mol) was added dropwise with concomitant heating to maintain a temperature of 75° C. Addition of the isocyanate was temporarily ceased if the temperature exceeded 78° C. The reaction contents were then heated at 75° C. for five hours, during which time the NCO value was reduced to <0.6%. If the NCO value was >0.6%, then 2 g of catalyst were added and heating was continued. If the NCO value was between 0.12% and 0.60%, an equivalent amount of methanol was added, calculated relative to residual NCO, and the reaction was continued until the NCO value was <0.12%. The resulting product was analyzed by gel permeation chromatography and determined to have a number average molecular weight of (Mₙ) 846 g/mol and weight average molecular weight (M_{w}) 1922 g/mol. The product was allowed to cool and was discharged.

### Oligomers B-F

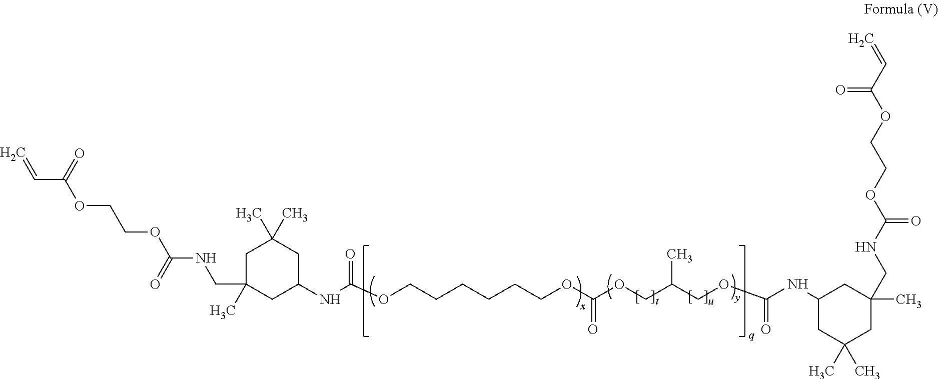

Oligomers B, C, D E, and F were prepared according to following procedures and are represented according to Formula (V). Oligomer B: A polycarbonate diol (Polyol C-590R, 300.91 g, about 0.60 mol, about 1.20 mol of OH groups), hydroxyethyl acrylate (125.61 g, 0.97 mol), ethyl acetate (300.77 g), hydroquinone methyl ether (0.050 g; 0.4 mmol), butylated hydroxytoluene (1.0 g; 4.5 mmol), phenothiazine (0.1 g; 0.5 mmol), and a zinc neodecanoate catalyst (1.0 g, 2.45 mmol) were introduced to a 1.5 L kettle style reactor with a nitrogen inlet and condenser. The temperature was increased to 35° C., and isophorone diisocyanate (267.54 g, 1.20 mol) was added dropwise with concomitant heating to maintain a temperature of 75° C. Addition of the isocyanate was temporarily ceased if the temperature exceeded 78° C. The reaction contents were then heated at 75° C. for five hours at which time the NCO value was reduced to <0.6%. If the NCO value was >0.6%, then 2 g of catalyst were added and heating was continued. If the NCO value was between 0.12% and 0.60%, an equivalent amount of methanol was added, calculated relative to residual NCO, and the reaction was continued until the NCO value was <0.12%. The resulting product was analyzed by gel permeation chromatography and determined to have Mₙ of 1174 g/mol and M_{w} of g/mol. The product was allowed to cool and was discharged.

Oligomer C: 420.5 g of a polycarbonate diol (Polyol C-1090, about 0.42 mol, about 0.84 mol of OH groups), 87.7 g of hydroxyethyl acrylate (0.76 mol), 301.4 g of ethyl acetate, hydroquinone methyl ether (0.050 g; 0.4 mmol), butylated hydroxytoluene (1.0 g; 4.5 mmol), phenothiazine (0.1 g; 0.5 mmol), and a zinc neodecanoate catalyst (1.0 g, 2.45 mmol) were introduced into a 1.5 L kettle-style reactor with nitrogen inlet and condenser. The temperature is increased to 35° C., and 186.8 g (0.84 moles) of isophorone diisocyanate were added dropwise with concomitant heating to maintain a temperature of 75° C. Addition of the isocyanate was temporarily ceased if the temperature exceeded 78° C. The reaction contents were then heated at 75° C. for 5 h at which time the NCO value was reduced to <0.6%. If the NCO value was >0.4%, then 2 g of catalyst were added and heating was continued. If the NCO value was between 0.12% and 0.40%, the equivalent amount of methanol was added, calculated relative to residual NCO, and reaction was continued until the NCO value was <0.12%. The resulting product was analyzed by gel permeation chromatography and determined to have Mₙ equal to 1,602 g/mol and M_{w} equal to 5,774 g/mol. The product was allowed to cool and was discharged.

Oligomer D: 527.18 g of a polycarbonate diol (Polyol C-2090, about 0.26 mol, about 0.52 mol of OH groups), 54.99 g of hydroxyethyl acrylate (0.47 mol), 298.45 g of ethyl acetate (about 3.39 mol), hydroquinone methyl ether (0.050 g; 0.4 mmol), butylated hydroxytoluene (1.0 g; 4.5 mmol), phenothiazine (0.1 g; 0.5 mmol), and a zinc neodecanoate catalyst (1.0 g, 2.45 mmol) were introduced into a 1.5 L kettle-style reactor with nitrogen inlet and condenser. The temperature was increased to 35° C., and 117.12 g (0.53 mol) of isophorone diisocyanate were added dropwise with concomitant heating to maintain a temperature of 75° C. Addition of the isocyanate was temporarily ceased if the temperature exceeded 78° C. The reaction contents were then heated at 75° C. for 5 h at which time the NCO value was reduced to <0.6%. If the NCO value was >0.4%, then 2 g of catalyst were added and heating was continued. If the NCO value was between 0.12% and 0.40%, the equivalent amount of methanol was added, calculated relative to residual NCO, and reaction was continued until the NCO value was <0.12%. The resulting product was analyzed by gel permeation chromatography and determined to have Mₙ equal to 2,482 g/mol and M_{w} equal to 11,527 g/mol. The product was allowed to cool and was discharged.

Oligomer E: 527.18 g of a polycarbonate diol (Polyol C-2050R, about 0.26 moles, about 0.52 moles of OH groups), 54.99 g of hydroxyethyl acrylate (0.47 mol), 298.45 g of ethyl acetate (about 3.39 mol), hydroquinone methyl ether (0.050 g; 0.4 mmol), butylated hydroxytoluene (1.0 g; 4.5 mmol), phenothiazine (0.1 g; 0.5 mmol), and a zinc neodecanoate catalyst (1.0 g, 2.45 mmol) were introduced into a 1.5 L kettle-style reactor with nitrogen inlet and condenser. The temperature was increased to 35° C., and 117.12 g (0.53 mol) of isophorone diisocyanate were added dropwise with concomitant heating to maintain a temperature of 75° C. Addition of the isocyanate was temporarily ceased if the temperature exceeded 78° C. The reaction contents were then heated at 75° C. for 5 h at which time the NCO value was reduced to <0.6%. If the NCO value was >0.4%, then 2 g of catalyst were added and heating was continued. If the NCO value was between 0.12% and 0.40%, the equivalent amount of methanol was added, calculated relative to residual NCO, and reaction was continued until the NCO value was <0.12%. The resulting product was analyzed by gel permeation chromatography and determined to have Mₙ equal to 2,683 g/mol and M_{w} equal to 12,512 g/mol. The product was allowed to cool and was discharged.

Oligomer F: 561.32 g of a polycarbonate diol (Polyol C-3090R, about 0.19 mol, about 0.38 mol of OH groups), 43.56 g of hydroxyethyl acrylate (0.38 mol), 300.53 g of ethyl acetate (3.41 mol), hydroquinone methyl ether (0.050 g; 0.4 mmol), butylated hydroxytoluene (1.0 g; 4.5 mmol), phenothiazine (0.1 g; 0.5 mmol), and a zinc neodecanoate catalyst (1.0 g, 2.45 mmol) were introduced into a 1.5 L kettle-style reactor with nitrogen inlet and condenser. The temperature was increased to 35° C., and 92.79 g (0.42 mol) of isophorone diisocyanate were added dropwise with concomitant heating to maintain a temperature of 75° C. Addition of the isocyanate was temporarily ceased if the temperature exceeded 78° C. The reaction contents were then heated at 75° C. for 5 h at which time the NCO value was reduced to <0.6%. If the NCO value was >0.4%, then 2 g of catalyst were added and heating was continued. If the NCO value was between 0.12% and 0.40%, the equivalent amount of methanol was added, calculated relative to residual NCO, and the reaction was continued until the NCO value was <0.12%. The resulting product was analyzed by gel permeation chromatography and determined to have Mₙ equal to 2,596 g/mol and M_{w} equal to 14,055 g/mol. The product was allowed to cool and was discharged.

Oligomer G. According to the synthetic procedure described is Oligomer A, the isocyanate was changed from IPDI to HMDI. The resulting product was analyzed by gel permeation chromatography and determined to have Mₙ equal to 1206 g/mol and M_{w} equal to 2721 g/mol.

Oligomer H. According to the synthetic procedure described is Oligomer A, the polyol was changed from polyTHF to polyethylene glycol with a molecular weight of 600 g/mol. The resulting product was analyzed by gel permeation chromatography and determined to have Mₙ equal to 2280 g/mol and M_{w} equal to 3424 g/mol.

Oligomer I. According to the synthetic procedure described is Oligomer A, the polyol was changed from polyTHF with a 250 molecular weight to a polyethylene oxide with a molecular weight of 590 g/mol. The resulting product was analyzed by gel permeation chromatography and determined to have Mₙ equal to 1710 g/mol and M_{w} equal to 3308 g/mol.

Oligomer 1. Oligomer 1 was prepared according to US 2007/0066704 (Example 1). 70 g by weight of Oligomer 1 was added to 30 g of trimethylolpropane formal acrylate.

Oligomer 2. Oligomer 2 was prepared according to WO 2016/089271 (Example 3). oligomer 2 has an about 500 g/mol to about 1000 g/mol polyol segment. 70 g by weight of Oligomer 2 was added to 30 g of trimethylolpropane formal acrylate.

### Example 2. Compositions

Compositions containing Oligomers 1 and 2 were prepared according to Table 1 (Compositions 2 and 3, respectively). The compositions were prepared by blending isobornyl acrylate (IBOA)(Sigma-Aldrich), n-vinyl caprolactam (NVC), phenoxyethyl acrylate (POEA), hexanediol diacrylate (HDDA), and 4-tert-butyl cyclohexyl acrylate (TBCH) with Oligomer 1 or Oligomer 2. Diphenyl(2,4,6-trimethylbenzoyl)phosphine oxide (TPO) was added as a photoinitiator in a range from 0.5 to 4 wt. % to provide Compositions 2 and 3. Compositions 2 and 3 were formulated to contain 80-83.5 wt. % of Oligomer 1 and Oligomer 2, respectively, by removing an appropriate amount of solvent by vacuum distillation. NVC, POEA, HDDA, TBCH, and TPO were obtained from BASF (Ludwigshafen, Germany) and used as received.

Composition 1 was obtained following a similar procedure as above by blending a combination of Oligomer A as prepared in Example 1 with IBOA and NVC. Oligomer A was also a blend of 70 wt. % of the oligomer and 30 wt. % ethyl acetate. The product was blended with the monomers and the ethyl acetate was removed from the mixture by vacuum distillation. Like Compositions 2 and 3, Composition 1 was formulated to contain 80-83.5 wt. % of Oligomer A by removing an appropriate amount of ethyl acetate by vacuum distillation.

Composition 4 (high monomer content) was obtained by diluting Composition 2 to a 40 wt. % blend and adding the monomers POEA, HDDA, and TBCH. The 40 wt. % dilution of Composition 2 corresponds to 32 wt. % Oligomer 1, 4.8 wt. % NVC, 1.6 wt. % IBOA, and a portion of the TPO. Additional TPO was added to maintain a 4 wt. % content.

TABLE 1

| | Composition | Composition | Composition | Composition |
|---|---|---|---|---|
| | 1 | 2 | 3 | 4* |
| Oligomer 1 | | 80-83.5 | | 32 |
| Oligomer 2 | | | 80-83.5 | |
| Oligomer A | 80-83.5 | | | |
| NVC | 12 | 12 | 12 | 4.8 |
| IBOA | 4 | 4 | 4 | 1.6 |
| POEA | | | | 9.3 |
| HDDA | | | | 37.9 |
| TBCH | | | | 10.4 |
| TPO | 0.5-4 | 0.5-4 | 0.5-4 | 4 |

Composition 5: An oligomer blend was prepared from 70 g of Oligomer 2 and 30 parts t-butyl cyclohexyl acrylate. The following composition was prepared from the oligomer blend (40 g), NVC (6 g), IBOA (2 g), TPO (2 g), and 50 g of one or more of the following monomers: NVC, DVE-3, IBOA, TBCH, POEA, HDDA, TPGDA, DPGDA, or PPTTA.

Composition 6: An oligomer blend was prepared from 70 g of Oligomer 2 and 30 g tripropylene glycol diacrylate. The following composition was prepared by combining the oligomer blend (40 g), NVC (6 g), IBOA (2 g), TPO (2 g), and 50 g of one or more of the following monomers: NVC, DVE-3, IBOA, TBCH, POEA, HDDA, TPGDA, DPGDA, or PPTTA.

Composition 7: The following composition was prepared by combining Oligomer 1 (32 g), NVC (4.8 g), IBOA (1.6 g), TPO (1.6 g), and 60 g of one or more of the following monomers: NVC, DVE-3, IBOA, TBCH, POEA, HDDA, TPGDA, DPGDA, or PPTTA.

Compositions 8-12 were prepared according to the procedure described for Composition 1, however, Oligomer A was replaced by each of Oligomers B, C, D, E, and F, respectively.

### Example 3. Evaluation of Properties

Tensile strength testing measurements were performed on an Instron (Norwood, Mass.) Model 3343 testing machine with a 1 kN load cell using a 65 mm test length and 6.5 mm/minute strain rate. Measurements were acquired using ASTM Method D638 with a Type IV specimen.

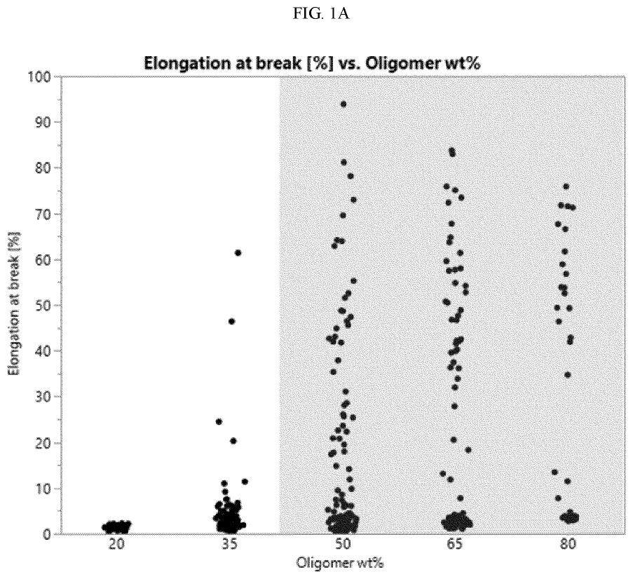

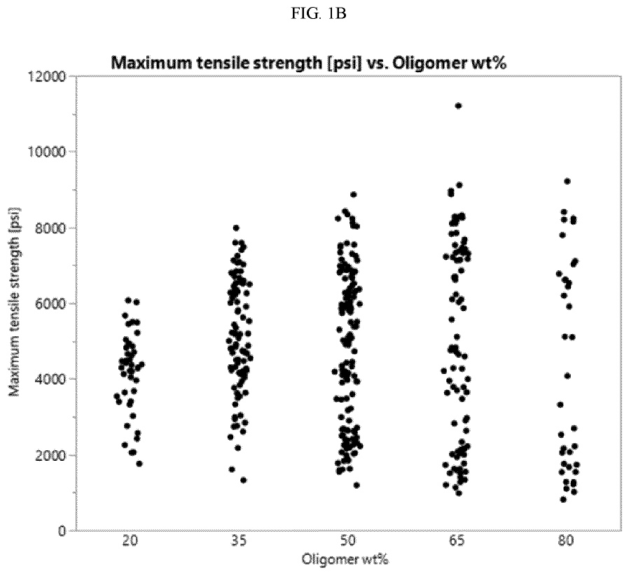

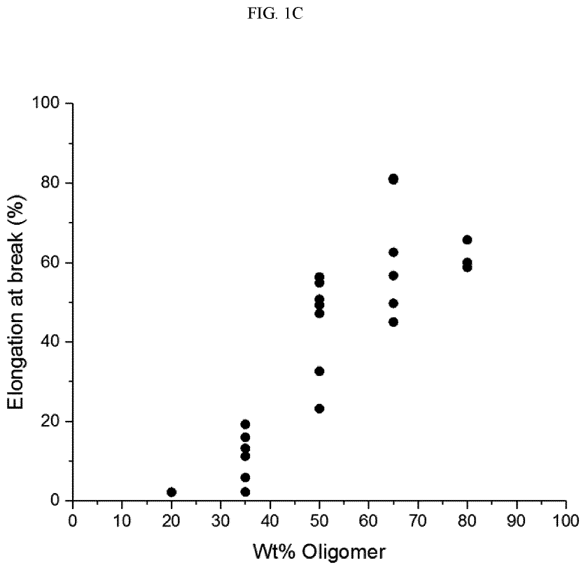

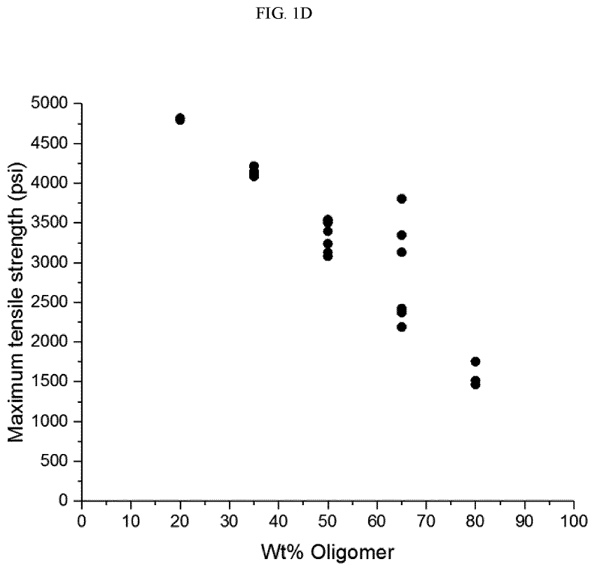

FIG. 1C shows the effect of oligomer content on the elongation properties of an oligomer based on IPDI and a 590 MW polyether polyol (Oligomer I). FIG. 1D shows the specific example of the effect of oligomer content on the tensile properties of Oligomer I. The data from FIGS. 1C and 1D were used to create FIGS. 1A and 1B, respectively.

FIG. 1A shows the elongation properties of a large number of monomer/oligomer combinations over a wide range of oligomer levels in the composition. Each point represents a single tensile/elongation measurement of a single composition. At oligomer concentrations below 50%, the elongation properties of the composition are dominated by the monomers used in the composition. At oligomer concentrations at 50% and above, the range of elongation values observed are very similar, although the percentage of elongation values at the low end of the scale below 20% elongation continues to increase as the weight percent of oligomer continues to increase.

FIG. 1B shows the tensile properties of a large number of monomer/oligomer combinations over a wide range of oligomer levels in the composition. Each point represents a single tensile/elongation measurement of a single composition. In contrast, to FIG. 1A shows the effect of increasing weight percent oligomer on tensile values. The mean value of the maximum tensile strength is relatively constant at 35 weight percent oligomer and above.

### Effect of Photoinitiator Content on Modulus in Multilayer System

High oligomer composition film samples according to Composition 3 were prepared having one or more layers, where each layer was about 63.5 micron thick. The amount of photoinitiator in each composition was varied from 0.5 wt. %, 1 wt. %, and 2 wt. %. The films were made by coating on Q-lab (Ohio, United States) 3″×6″ Q-panel aluminum test substrates. Films with multiple layers were prepared by initially coating the composition directly onto a Q-panel using 63.5 μm K Hand Coater and applying subsequent layers on top.

The sample was cured in a Heraeus Noblelight (Maryland, United States) Fusion DRS-10/12 conveyor system equipped with two side-by-side Heraeus Light Hammer 6 I6B lamps with H Mercury vapor lamps. The lamps were operated at 65% power, the conveyor belt was operated at 20 ft/min. Irradiance and dose were measured using an EIT (Virginia, United States) UV Power Puck (Model PP2000) high energy UV integrating radiometer as provided in Table 2 below. Following application of Composition 3 to the Q-Panel, each layer was passed through the Fusion curing system 4 times after each layer of the composition was applied until the desired number of layers were deposited.

TABLE 2

| | UV-A | UV-B | UV-C | UV-V |
|---|---|---|---|---|
| Irradiance | 0.44 | 0.49 | 0.073 | 0.35 |
| (W/cm²) | | | | |
| Dose | 0.36 | 0.40 | 0.057 | 0.29 |
| (J/cm²⁻) | | | | |

The films were characterized through dynamic mechanical analysis (DMA) and tensile testing (stress/strain) measurements, both performed on a TA DMA Q800 using the film tension mode. DMA measurements were taken by equilibrating at 15° C., then ramping the temperature to 95° C. at a rate of 5° C./min. The storage modulus (E′) measurements were recorded at 25° C., 30° C., and 90° C. The amplitude of oscillation was 0.1%, the preload force was 0.01 N, and the force track was 125%. Tensile testing measurements were taken using strain rate of 10%/min at a constant temperature of 25° C. The preload force was 0.01 N and the initial strain was 0.1%.

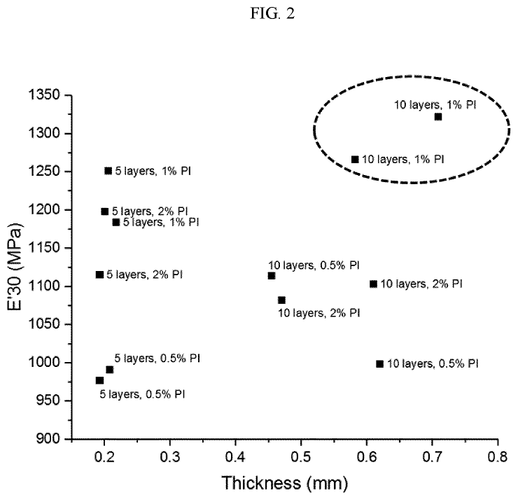

FIG. 2 illustrates that there was an increase in modulus with the increase in the number layers. When the photoinitiator amount increases to 2 wt. %, the modulus decreases with increasing number of layers.

### Effect of Oligomer Structure Soft Segment on Modulus

Individual film samples with multiple layers were prepared by initially coating Compositions 8-12 directly onto the Q-panel using the 63.5 μm K Hand Coater and applying subsequent layers on top. Each sample was cured using the settings described above after each layer of the composition was applied until the desired number of layers had been deposited.

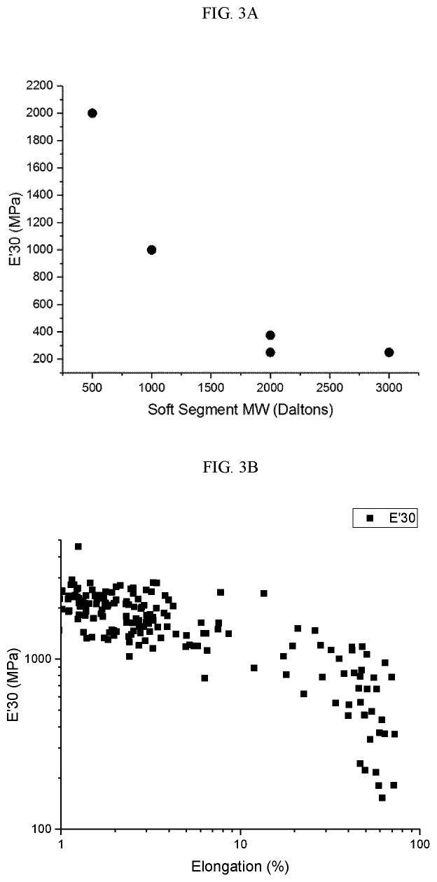

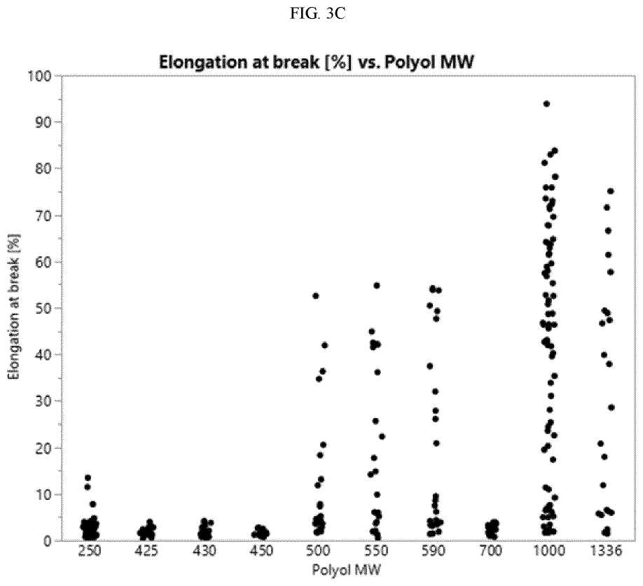

Table 3 corresponds to the compositions in FIG. 3A. FIG. 3A shows that compositions containing oligomers with a polyol segment (i.e., soft segment) molecular weight of less than about 1000 g/mol exhibited higher modulus. In contrast, compositions containing oligomers with polyol segment greater than 1000 g/mol exhibited a lower modulus. FIG. 3B shows that the modulus is essentially invariant up to an elongation of approximately 10%, and then sharply decreases by an order of magnitude at elongations greater than 10%. FIG. 3C shows that the onset effect of polyol segment molecular weight on elongation at break is quite significant across a wide range of polyol and isocyanate types. Below a molecular weight of 500 g/mol, there are no compositions with an elongation higher than 15%, but at a molecular weight of 500 g/mol and above the maximum elongation increases to 50% and higher.

TABLE 3

| Example | Polyol MW | E′30 (MPa) |
|---|---|---|
| Oligomer C | 1000 | 1000 |
| Oligomer D | 2000 | 375 |
| Oligomer E | 2000 | 250 |
| Oligomer B | 500 | 2000 |
| Oligomer F | 3000 | 250 |

### Effect of Composition Weight Loss for High Monomer Compositions and High Oligomer Compositions

Composition 2 was evaluated to determine the rate of weight loss when subjected to a temperature of 70° C. over an extended period of time. Comparative evaluation was performed using a low viscosity, high monomer composition of isobornyl acrylate.

To determine mass loss over time at 70° C., thermogravimetric analysis (TGA) measurements were performed using a TA Instruments (Delaware, United States) TGA Q50 analyzer. TGA data were measured using a balance purge of 10 mL/min and a sample purge of 90 mL/min. Approximately 15 mg of the sample was placed in a platinum TGA pan, and the sample was heated isothermally for 1 hour.

FIG. 4 illustrates a significant portion of the high monomer content was lost through volatilization. In contrast, Composition 2 according to present technology exhibited a significantly lower rate of weight loss, which demonstrates that the composition of the present technology which would actually emerge from the printhead does not differ over time from the initial composition. On the other hand, the high monomer composition would emerge as a substantially different composition on the platen substrate, which would be expected to cause time-dependent changes in material properties of the 3D object.

### Effect of Long Wavelength Secondary Irradiation of Compositions

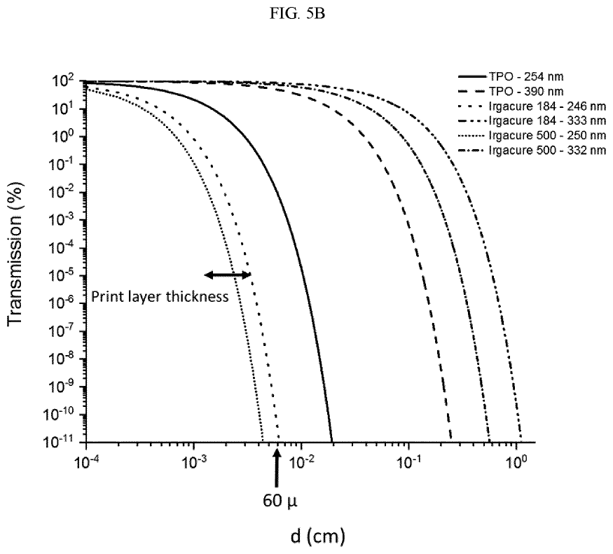

A 63.5 micron thick film sample according to Composition 2 was cured following the UV curing process described above. The film sample was subsequently irradiated at 390 nm for 2 seconds at a peak temperature of about 60° C. As shown in FIG. 5A, the post curing resulted in a 30% increase in the modulus at 25° C. The basis for this approach is shown in FIG. 5B.

FIG. 5B illustrates the effect layer thickness of inkjet printed compositions according to Composition 2 on %-transmission of light at short wavelength (246 nm, 250 nm, 254 nm) and long wavelength (332 nm, 333 nm, and 390 nm), respectively. Composition 2 is based on a 4 wt. % photoinitiator amount of either TPO, 1-hydroxy-cyclohexyl-phenyl-ketone (available from Ciba, Irgacure 184), and a 1:1 mixture of 1-hydroxy-cyclohexyl-phenyl-ketone and benzophenone (mixture available from Ciba, Irgacure 500), respectively. The transmission of Irgacure 500 and Irgacure 184 in the region of 254 nm at a print layer thickness of 15-30μ has a transmission of approximately 10⁻⁵. TPO, in contrast, has a transmission 5 orders of magnitude higher over the same range of layer thicknesses, leading to a more homogeneous cure.

### Effect of Oligomer Structure and Molecular Weight on Mechanical Properties

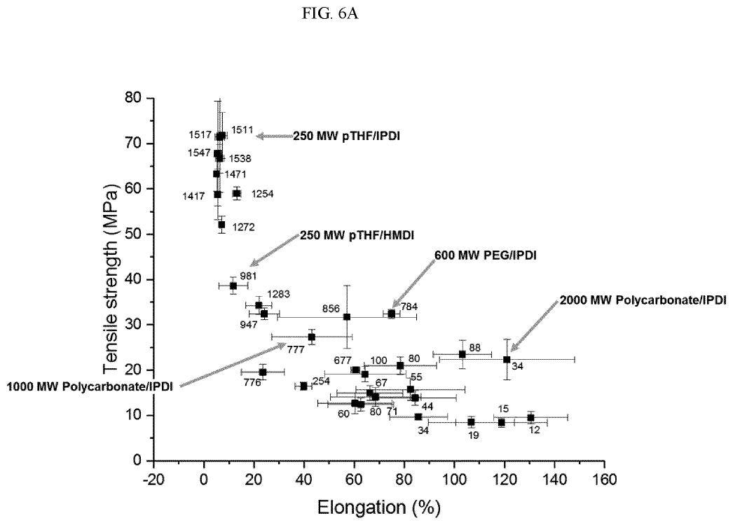

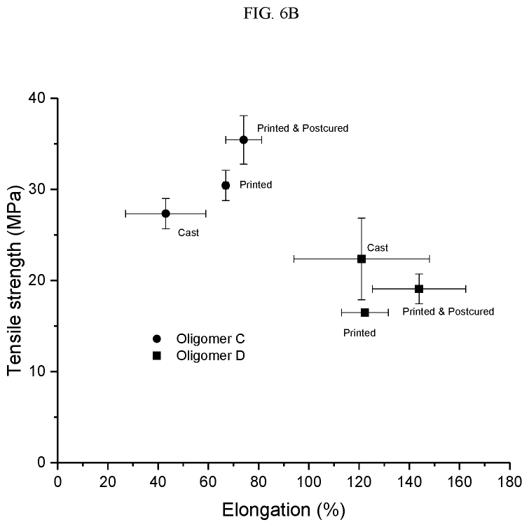

The samples whose mechanical properties are shown in FIG. 6A were prepared by filling a mold with the composition and curing the composition with 4 passes at the given settings on one side, then turning the samples over and curing them again with another 4 passes. The irradiance and dose from each pass is provided in Table 2. The samples labeled as “Cast” in FIG. 6B were prepared following the same method, those labeled “Printed” in FIG. 6B were printed on a DLP printer, and those labeled “Printed & Postcured” were printed on a DLP printer and received an additional postcuring at 390 nm under the same conditions as the samples shown in FIG. 5A. Tensile testing data shown in FIGS. 6A and 6B were obtained on the Instront using a 40 mm test length and 10 mm/min strain rate.

FIG. 6A illustrates the effect of the specific polyol structures and molecular weights shown in FIGS. 1A, 1B, 3B, and 3C on tensile strength, elongation, and modulus. The oligomers were formulated as a 60:40 blend of oligomer:acryloyl morpholine (“ACMO”), with 1% TPO-L added as photoinitiator. As illustrated in FIG. 6A and Table 4, modifying the polyol molecular weight and isocyanate structure affect the mechanical properties. In particular, the polyol molecular weight has the most significant effect on mechanical properties. The numbers next to each data point in FIG. 6A indicates the Young's modulus (MPa). In particular, elongation and the choice of isocyanate can have a dominant effect on tensile strength. For example, the IPDI and HMDI urethane acrylates based on pTHF having a molecular weight of 250 g/mol have the same elongation, but the use of HMDI yields approximately half the tensile strength and modulus of the IPDI based analog.

Additionally, FIG. 6A shows that the tensile strength and elongation properties of a wide range of polyol/isocyanate combinations. The mechanical properties resulting from the specific combination of polyol and isocyanate can be adjusted to meet the requirements of desired end use application properties through careful selection of the structure and molecular weight of the polyol and the isocyanate. For example, in commercial applications such as the 3D printing of electrical connectors in which high rigidity is required, the properties achieved from a combination of 250 MW poly-THF and isophorone diisocyanate would be of interest. In contrast, in commercial applications such as the 3D printing of shoe soles, where resilience and flexibility are desired, a higher molecular weight polyol such as a polycarbonate polyol would be of interest.

TABLE 4

| | | | Elonga- | | Young's |
|---|---|---|---|---|---|
| | | Iso- | tion | Tensile | Modulus |
| | Polyol | cyanate | % | MPa | MPa |
| Oligomer A | 250 MW pTHF | IPDI | 7.3 | 71.8 | 1511 |
| Oligomer G | 250 MW pTHF | HMDI | 11.7 | 38.6 | 981 |
| Oligomer C | 1000 MW | IPDI | 43.0 | 27.3 | 777 |
| | Polycarbonate | | | | |
| Oligomer D | 2000 MW | IPDI | 121 | 22.3 | 34 |
| | Polycarbonate | | | | |
| Oligomer H | 600 MW PEG | IPDI | 75 | 32.4 | 784 |

### Effect of Sample Preparation and Curing Method on Mechanical Properties

FIG. 6B illustrates the effect of sample preparation and curing method on tensile and percent elongation. The samples consist of blends of urethane acrylates based on the 1000 MW and 2000 MW polycarbonates shown in FIG. 6A. Although the DLP printed samples (“printed”) tend to exhibit higher elongation, the mechanical properties of cast printed, and postcured samples are similar. The postcuring was carried out using the methodology illustrated in FIG. 5A.

The above examples illustrates the oligomers and compositions of the present technology allow for three-dimensional articles having improved tensile strength, modulus, and elongation. Furthermore, the results illustrate the compositions exhibit improved mechanical and chemical properties suitable for three-dimensional inkjet printing applications and related applications described herein.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A composition comprising:
one or more ethylenically unsaturated monomers; and
(a) one or more oligomers represented by Formula (I): 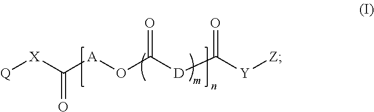
wherein:
A is derived from one or more poly hydroxyl group compounds having a number average molecular weight (Mₙ) from about 250 to about 3000 g/mol;
D, X, and Y are independently urethane or carbamate linkages derived from one or more polyisocyanates;
Q and Z are independently derived from one or more compounds having at least one ethylenically unsaturated group;
n is an integer from 1 to 20; and
m is an integer from 0 to 20;
(b) one or more commercial urethane acrylates, wherein the commercial urethane acrylates are derived from the group consisting of polyether, polyester, polycarbonate, alkyl or aryl polyols, alkyl or aryl polyisocyanates, hydroxyl functional (meth)acrylates, and blends of polyols and/or isocyanates; or
(c) a combination of (a) and (b);
wherein the composition is a 3D UV curable composition.

2. The composition of claim 1, wherein A is 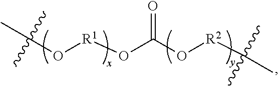
wherein:
R¹ and R² are independently derived from a di- or triol polyester, polyether polycarbonate, or a linear or branched C₁-C₁₀ alkane;
x is an integer from 1 to 20; and
y is an integer from 0 to 20.

3. (canceled)

4. The composition of claim 1, wherein A is derived from:
polyethylene glycol;
a compound of Formula (II): 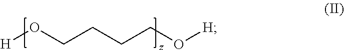
or
a compound of Formula (III): 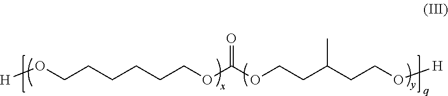
wherein:
q is 1-20;
x is 1-20;
y is 1-20; and
z is 1-40.

5. The composition of claim 1, wherein D is 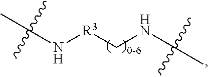
wherein R³ is a substituted or unsubstituted arylene, substituted or unsubstituted cycloalkylene, or substituted or unsubstituted C₁-C₁₀-alkylene.

6. The composition of claim 1, wherein X and Y are independently 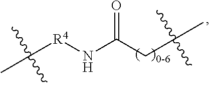
wherein R⁴ is a substituted or unsubstituted arylene, substituted or unsubstituted cycloalkylene, or substituted or unsubstituted C₁-C₁₀-alkylene.

7. The composition of claim 5, wherein R³ and R⁴ are independently selected from the group consisting of:

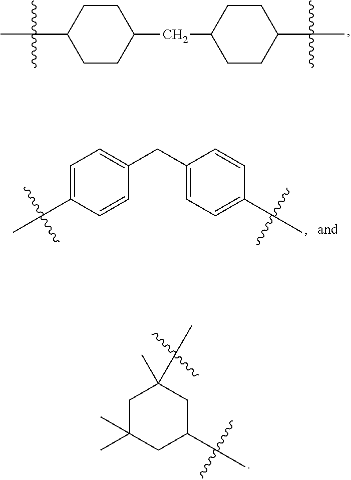 [SMILES: *C1CCC(CC2CCC(*)CC2)CC1 ; *c1ccc(Cc2ccc(*)cc2)cc1 ; *C1CC(*)(C)CC(C)(C)C1]

8. The composition of claim 1, wherein D, X, and Y are independently urethane or carbamate linkages derived from the one or more polyisocyanates selected from the group consisting of tetramethylene diisocyanate, hexamethylene diisocyanate, octamethylene diisocyanate, decamethylene diisocyanate, dodecamethylene diisocyanate, tetradecamethylene diisocyanate, lysine diisocyanate, tetramethylxylylene diisocyanate, trimethylhexane diisocyanate, tetramethylhexane diisocyanate, 1,4-diisocyanatocyclohexane, 1,3-diisocyanatocyclohexane, 1,2-diisocyanatocyclohexane, 4,4′-di(isocyanatocyclohexyl)methane, 2,4′-di(isocyanatocyclohexyl)methane, 1,3-bis(isocyanatomethyl)cyclohexane, 1,4-bis(isocyanatomethyl)cyclohexane, 2,4-diisocyanato-1-methylcyclohexane, 2,6-diisocyanato-1-methylcyclohexane, tolylene-2,4-diisocyanate, tolylene-2,6-diisocyanate, m-xylylene diisocyanate, p-xylylene diisocyanate, 2,4′-diisocyanato-diphenylmethane, 4,4′-diisocyanato-diphenylmethane, phenylene-1,3Diisocyanate, phenylene-1,4-diisocyanate, 1-chlorophenylene-2,4-diisocyanate, naphthylene-1,5-diisocyanate, diphenylene-4,4′-diisocyanate, 4,4′-diisocyanato-3,3′-dimethylbiphenyl, 3-methyldiphenylmethane-4,4′-diisocyanate, tetramethylxylylene diisocyanate, 1,4-diisocyanatobenzene, diphenylether-4,4′-diisocyanate, 1,4-diisocyanatobutane, 1,5-diisocyanatopentane, hexamethylene diisocyanate (HDI), 1,11-diisocyanatoundecane, 1,12-diisocyanatododecane, 2,2,4-trimethyl-1,6-diisocyanatohexane, 2,4,4-trimethyl-1,6-diisocyanatohexane, isophorone diisocyanate (IPDI), methylene diphenyl diisocyanate (MDI), 1,3Diisocyanatocyclobutane, 1,3-diisocyanatocyclohexane, 1,4-diisocyanatocyclohexane, 4,4′-bis-(isocyanatocyclohexyl)-methane (HMDI), 1,2-bis-(isocyanatomethyl)-cyclobutane, 1,3-bis-(isocyanatomethyl)-cyclohexane, 1,4-bis-(isocyanatomethyl)-cyclohexane, hexahydro-2,4-diisocyanatotoluene, hexahydro-2,6-diisocyanatotoluene, bis-isocyanatomethyl norbornane, 2,5-bis-(isocyanatomethyl)-bicyclo[2.2.1]heptane, 2,6-bis-(isocyanatomethyl)-bicyclo[2.2.1]heptane, 1-isocyanato-4(3)-isocyanatomethyl-1-methyl cyclohexane, p-xylylene diisocyanate, 2,3-bis-(8-isocyanatooctyl)-4-octyl-5-hexyl cyclohexane, and mixtures of two or more thereof.

9. (canceled)

10. The composition of claim 1, wherein the one or more oligomers is selected from the group consisting of a compound represented by Formula (IV), Formula V, or a combination thereof: 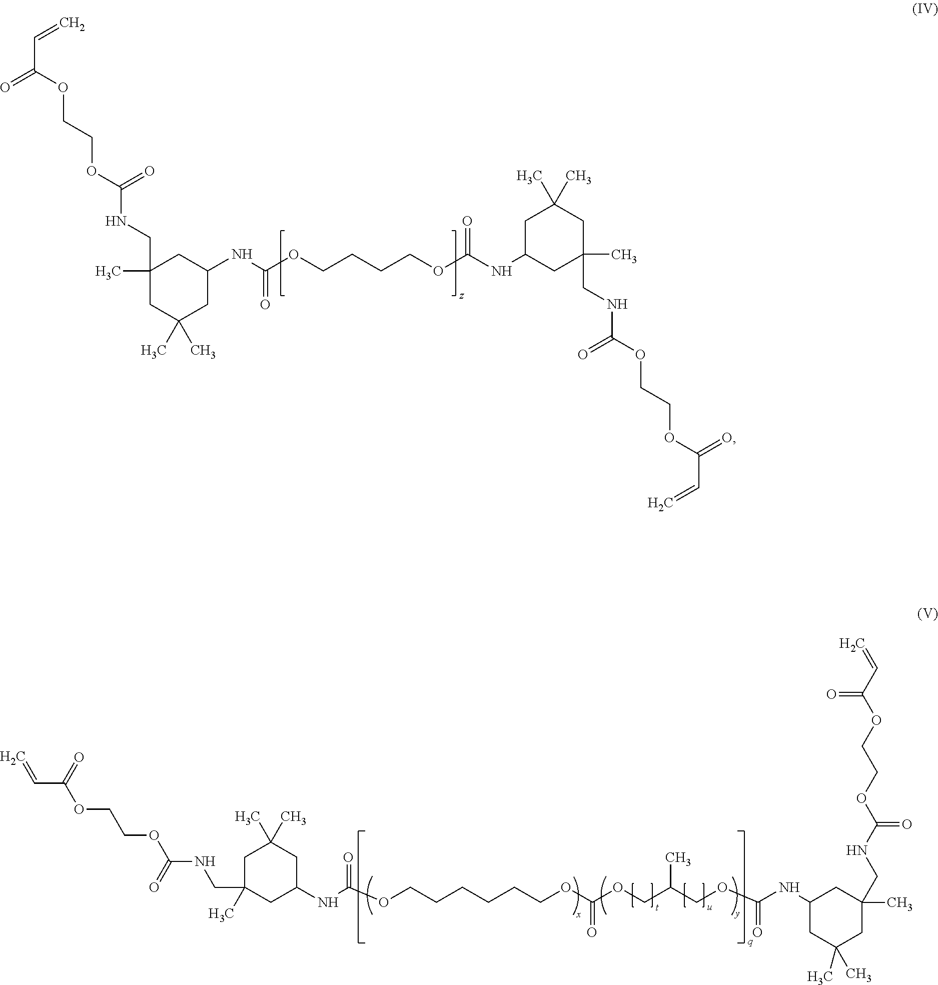
wherein z is an integer from 1-40, t is 2, u is 2, q is an integer from 1 to 20, x is an integer from 1 to 20, and y is an integer from 1 to 20.

11. (canceled)

12. The composition of claim 1, wherein the composition comprises from about 55 wt. % to about 85 wt. % of the one or more oligomers.

13. (canceled)

14. The composition of claim 1, wherein the one or more ethylenically unsaturated monomers are selected from the group consisting of isobornyl acrylate, n-vinyl caprolactam, phenoxyethyl acrylate, tert-butyl cyclohexyl acrylate, hexanediol diacrylate, trimethylolpropane formal acrylate, polyethylene glycol diacrylate, isodecyl acrylate, hexyl acrylate, cyclohexyl acrylate, 2-ethylhexyl acrylate, octyl acrylate, nonyl acrylate, stearyl acrylate, 2-phenoxy acrylate, 2-methoxyethyl acrylate, lactone modified esters of acrylic and methacrylic acid, methyl methacrylate, butyl acrylate, isobutyl acrylate, methacrylamide, allyl acrylate, tetrahydrofuryl acrylate, n-hexyl methacrylate, 2-(2-ethoxy-ethoxy)ethyl acrylate, n-lauryl acrylate, 2-phenoxyethyl acrylate, glycidyl methacrylate, glycidyl acrylate, acrylated methylolmelamine, 2-(N,N-diethylamino)-ethyl acrylate, neopentyl glycol diacrylate, alkoxylated neopentyl glycol diacrylate, ethylene glycol diacrylate, hexylene glycol diacrylate, diethylene glycol diacrylate, tripropylene glycol diacrylate, tetraethylene glycol diacrylate, pentaerythritol di-, tri-, tetra-, or penta-acrylate, trimethylolpropane triacylate, alkoxylated trimethylolpropane triacrylate, triethylene glycol diacrylate, tetraethylene glycol diacrylate, polyethylene glycol diacrylate, any corresponding methacrylates thereof, N-vinylformamide (NVF), adducts of NVF with diisocyanates such as toluene diisocyanate and isophorone diisocyanate, derivatives of N-vinylformamide, N-vinylcaprolactam, N-vinylpyrrolidone, butyl-vinylether, 1,4-butyl-divinyl ether, dipropyleneglycol-divinylether, the vinylester of acetic acid, lauryl acid, dodecanoic acid or cyclohexylcarboxylic acid, adipic acid, glutaric acid or the like, triallylisocyanurate, diallylphthalate, butyl-allyl-ether, and a mixture of any two or more thereof.

15. (canceled)

16. The composition of claim 1, wherein the composition further comprises one or more photoinitiators.

17. The composition of claim 16, wherein the one or more photoinitiators is selected from the group consisting of bis(2,4,6-trimethylbenzoyl)-phenylphosphine oxide, 2,4,6-trimethylbenzoylphenyl phosphinate, bis(2,6-dimethoxybenzoyl)-2,4,4-trimethylpentylphosphine oxide, diphenyl(2,4,6-trimethylbenzoyl)phosphine oxide, alpha-hydroxycyclohexyl phenyl ketone, 2-hydroxy-1-(4-(4-(2-hydroxy-2-methylpropionyl)benzyl)phenyl-2-methylpropan-1-one, 2-hydroxy-2-methyl-1-phenylpropanone, 2-hydroxy-2-methyl-1-(4-isopropylphenyl)propanone, oligo (2-hydroxy-2-methyl-1-(4-(1-methylvinyl)phenyl)propanone, 2-hydroxy-2-methyl-1-(4-dodecylphenyl)propanone, 2-hydroxy-2-methyl-1-[(2-hydroxyethoxy)phenyl]propanone, benzophenone, substituted benzophenones, and a mixture of any two or more thereof.

18-24. (canceled)

25. The composition of claim 1, wherein the composition further comprises nanoparticles selected from the group consisting of organocation-modified phyllosilicates, TiO₂, ZnO, Ag, SiO₂, Fe₃O₄, CaCO₃, Al₂O₃, Mg(OH)₂, Al(OH)₃, CeO₂, MnO₂, cellulose, graphene, carbon fiber, carbon nanotube, cloisite, montmorillonite, hectorite, saponite, and mixtures of two or more thereof.

26-29. (canceled)

30. The composition of claim 1, wherein the composition further comprises a compound of Formula (VI): 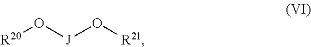
wherein
R²⁰ and R²¹ independently comprise a (meth)acrylate moiety derived from one or more compounds comprising at least one ethylenically unsaturated group; and
J is a divalent urethane compound derived from one or more polyisocyanates.

31-33. (canceled)

34. A process for preparing the composition of claim 1, the process comprising preparing the one or more oligomers comprising:
reacting the one or more polyisocyanates, the one or more compounds comprising at least one ethylenically unsaturated group, and the one or more poly hydroxyl group compounds,
wherein:
the process is carried out thermally or in the presence of a catalyst.

35-39. (canceled)

40. A method of preparing a three-dimensional article, wherein the method comprises applying successive layers of one or more of the compositions of claim 1 to fabricate a three-dimensional article; and irradiating the successive layers with UV irradiation.

41-52. (canceled)

53. An oligomer compound comprising one or more ethylenically unsaturated groups, wherein the oligomer is a compound represented by Formula (I): 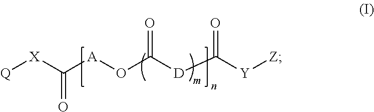
wherein:
A is derived from one or more poly hydroxyl group compounds having a number average molecular weight (Mₙ) less than 1000 g/mol;
D, X, and Y are independently urethane or carbamate linkages derived from one or more polyisocyanates;
Q and Z are independently derived from one or more compounds having at least one ethylenically unsaturated group;
n is an integer from 1 to 20; and
m is an integer from 0 to 20.

54-62. (canceled)

63. A composition comprising the oligomer of claim 53, wherein the composition is a 3D UV curable composition.

64. (canceled)

65. A process for preparing the oligomer of claim 53, the process comprising:
reacting one or more polyisocyanates with one or more compounds comprising at least one ethylenically unsaturated group and one or more poly hydroxyl group compounds,
wherein:
the process is carried out thermally or in the presence of a catalyst.

66-73. (canceled)
